(19) United States
(12) Patent Application Publication
(10) Pub. No.: US 2013/0315787 A1
(43) Pub. Date: Nov. 28, 2013

(54) NANOCRYSTALS AND METHODS AND USES THEREOF

(71) Applicant: The Regents of the University of Colorado, a body corporate, (US)

(72) Inventors: Gordana Dukovic, Boulder, CO (US); Kyureon Lee, Boulder, CO (US); Hiroko Nakao, Boulder, CO (US)

(73) Assignee: The Regents of the University of Colorado, a body corporate, Denver, CO (US)

(21) Appl. No.: 13/886,847

(22) Filed: May 3, 2013

Related U.S. Application Data
(60) Provisional application No. 61/642,690, filed on May 4, 2012.

(51) Int. Cl. B01J 27/24

(52) U.S. Cl. CPC B01J 27/24
USPC 422/162; 502/200

(57) ABSTRACT

Disclosed herein are (Ga₁₋ₓZnₓ)(N₁₋ₓOₓ) nanocrystals and syntheses and devices related thereto.

### CROSS-REFERENCE TO RELATED APPLICATIONS

This application claims the benefit of U.S. Provisional Application No. 61/642,690, filed on May 4, 2012. The entire disclosure of the above application is incorporated herein by reference.

### INTRODUCTION

This section provides background information related to the present disclosure which is not necessarily prior art.

Bulk oxy(nitride) (Ga₁₋ₓ)(N₁₋ₓOₓ), a solid solution of GaN and ZnO, is a remarkable material that can perform overall water splitting under visible illumination. Accordingly, in bulk form, the oxy(nitride) (Ga₁₋ₓZnₓ)(N₁₋ₓOₓ), a solid solution of GaN and ZnO, has attracted considerable attention in recent years because of the potential application in solar photocatalytic water splitting at wavelength >400 nm.¹⁻⁴ This material is a solid solution of ZnO and GaN and has the rare combination of visible absorption, appropriate band edges for the reduction and oxidation half-reactions required for water splitting, and resistance to photo-corrosion.¹⁻⁴ For the purposes of solar energy harvesting, it is necessary to decrease its band gap while maintaining sufficient driving force for water splitting. It is not well understood why (Ga₁₋ₓZnₓ)(N₁₋ₓOₓ) exhibits visible absorption given that GaN and ZnO have band gaps of 3.4 and 3.3 eV respectively.⁵⁻¹⁷ There is even disagreement between experimental reports of how bulk (Ga₁₋ₓZnₓ)(N₁₋ₓOₓ) band gaps depend on composition.^{5, 18} In materials prepared by mixing of ZnO and GaN powders under high pressures and temperatures, the oxy(nitride) with x=0.49 had a lower band gap (˜2.5 eV) than both GaN-rich (x=0.22) and ZnO-rich (x=0.76) materials.⁵ This behavior is known as band gap bowing. In contrast, in (Ga₁₋ₓZnₓ)(N₁₋ₓOₓ) synthesized by nitridation of layered double Zn²⁺ and Ga³⁺ hydroxides, the band gap decreased over the 0.46<x<0.81 range, to as low as 2.37 eV.¹⁸ This difference in behavior is not understood and it has important implications for how much of the solar spectrum can be harvested by the oxy(nitrides).

In addition, to control the composition and absorption spectra it is desirable to reduce the sizes of oxy(nitride) particles from the sub-micrometer bulk regime to dimensions in the nanometer scales, such as around 10 nm. In bulk (Ga₁₋ₓZnₓ)(N₁₋ₓOₓ) functionalized with a H⁺ reduction co-catalyst, the water-splitting quantum yield is governed by the competition between carrier migration, surface redox reactions, and carrier trapping and recombination.3, 19 The highest reported quantum yield of water splitting under visible illumination is 6%.²⁰ Nanocrystalline oxy(nitrides), with dimensions comparable or smaller than the mean free paths of electrons and holes in the material, may exhibit improved photochemical quantum yields. Because of high surface area-to-volume ratios and the lack of grain boundaries, the probability that a carrier would reach a catalytic surface site rather than decay via energy wasting relaxation pathways may be higher in nanocrystals than in the bulk form. Similar advantages of nanostructures over the bulk material have been demonstrated for Fe₂O₃ and KCa₂Nb₃O₁₀.^{21, 22} However, synthetic methods for oxy(nitrides) with sub-100 nm dimensions can be difficult.²³⁻²⁵ Notably, Han et al have reported synthesis of nanoparticles with diameters as low as 10 nm and values of x up to 0.48.²³ Oxy(nitride) nanocrystals with a wide range of compositions have not been previously reported. In particular, because of the possibility of achieving lowest band gaps at high values of x,¹⁸ ZnO-rich oxy(nitride) nanocrystals is likely to be particularly suitable for solar water splitting. Synthetic developments to control the material morphology and composition are not disclosed in the art.

Accordingly, there is a need for (Ga₁₋ₓZnₓ)(N₁₋ₓOₓ) compositions with high values of x and where x can be controlled. There is also need for synthetic methods to control the morphology and composition of (Ga₁₋ₓZnₓ)(N₁₋ₓQₓ) nanoparticles. Uses and devices of such (Ga₁₋ₓZ^{x})(N₁₋ₓOₓ) nanoparticles would have advantageous properties. Such (Ga₁₋ₓZnₓ)(N₁₋ₓOₓ) nanoparticles, methods, uses and devices are described herein.

### SUMMARY

The present technology includes systems, processes, articles of manufacture, and compositions that relate to (Ga₁₋ₓZnₓ)(N₁₋ₓOₓ) nanocrystals.

In accordance with the purpose(s), as embodied and broadly described herein, in one aspect, relates to (Ga₁₋ₓZnₓ)(N₁₋ₓOₓ) nanocrystals and syntheses and devices related thereto.

Disclosed herein are (Ga₁₋ₓZnₓ)(N₁₋ₓOₓ) nanocrystals and their synthesis. The (Ga₁₋ₓZnₓ)(N₁₋ₓOₓ) nanocrystals can have a broad range of compositions, for example, various forms of nanoscale (Ga₁₋ₓZnₓ)(N₁₋ₓOₓ) can have 0<x<1, about 0.125<x<1, about 0.85<x<about 0.95, and about 0.90. Other embodiments include where 0.3<x<1.0, where preferably x is greater than 0.50 or 0.80 and smaller than 1.00, more preferably x=about 0.90, wherein x is defined as Zn/(Zn+Ga). The absorption onsets of such materials can range from 2.7 (x=0.3) to 2.2 eV (x=0.9) and vary linearly with x.

In one aspect the (Ga₁₋ₓZnₓ)(N₁₋ₓOₓ) nanocrystals are single-crystalline particles. The (Ga₁₋ₓZnₓ)(N₁₋ₓOₓ) nanocrystals can have a size of about 5 nm-50 nm, preferably about 10-20 nm, and more preferably about 10 nm.

In a further aspect, the (Ga₁₋ₓZnₓ)(N₁₋ₓOₓ) nanocrystals split-water at quantum yields of %, 10%, 12%, or 15%, preferably above 10%, 12%, or 15%.

In a further aspect, the (Ga₁₋ₓZnₓ)(N₁₋ₓOₓ) nanocrystals can comprise a co-catalyze, such as Rh_{2-y}Cr_{y}O₃— wherein y is<2.

Also disclosed herein are compositions comprising the (Ga₁₋ₓZnₓ)(N₁₋ₓOₓ) nanocrystals.

Also disclosed herein are compositions comprising nanocrystalline ZnGa₂O₄ or Ga₂O₃ and nanocrystalline ZnO. In one aspect, the composition can further comprise a nitridation agent. Suitable nitridation agents include, but are not limited to, NH₃, such as anhydrous NH₃.

In one aspect, the nanocrystalline ZnGa₂O₄ can comprise a capping moiety. In a further aspect, the capping moiety can alter the hydrophobicity of the nanocrystalline ZnGa₂O₄. Suitable capping moieties include, but are not limited to 3-mercaptopropionic acid (MPA).

Also disclosed herein are methods of synthesizing a nanocrystal comprising the steps of a) depositing nanocrystalline ZnGa₂O₄ and nanocrystalline ZnO in a heating device; and b) heating the deposited nanocrystalline ZnGa₂O₄ and nanocrystalline ZnO with a nitridation agent, wherein the nanocrystal comprises a (Ga_{1-X}Zn)(N_{1-X}O_{X}), wherein x is 0.30 to less than 1.00. Suitable nitridation agents include, but are not limited to, NH₃, such as anhydrous NH₃. Using the nanocrystalline ZnGa₂O₄ and nanocrystalline ZnO as starting materials allows for the chemical transformations to occur at lower temperatures because the atomic diffusion needed would occur over short distances. The lowering of reaction temperature would, in turn, reduce the evaporation of Zn and prevent fusion of nanocrystals into the bulk form. X in the resulting (Ga_{1-X}Zn)(N_{1-X}O_{X}) nanocrystals can be controlled.

In one aspect, selecting a ratio of nanocrystalline ZnGa₂O₄to nanocrystalline ZnO in the method determines the value of x in the (Ga_{1-X}Zn)(N_{1-X}O_{X}) nanocrystals at a heating temperature that does not evaporate Zn, such as 650° C. At this temperature, the Zn:Ga ratio in the starting material mixture can be maintained in the product. The (Ga₁₋ₓZnₓ)(N₁₋ₓOₓ) nanocrystals can have improved photoexcited carrier behavior, when compared to the bulk. For example, the (Ga₁₋ₓZnₓ)(N₁₋ₓOₓ) nanocrystals may have high quantum yields of water splitting, such as above 5%, 10%, 12%, or 15%, preferably above 10%, 12%, or 15%. In a further aspect, the composition can have a ratio of nanocrystalline ZnGa₂O₄ to nanocrystalline ZnO of 1:0, 1:3, 1:5, 1:7, 1:10, 1:17, 1:37, 1:63 and 1:199. A 1:0 ration gives an x value of 0.33 while a 1:199 ration fives an x value of 0.99. Thus, by selecting suitable ratios of nanocrystalline ZnGa₂O₄to nanocrystalline ZnO, (Ga_{1-X}Zn)(N_{1-X}O_{X}) various nanocrystals can be produced, wherein 0<x<1, about 0.125<x<1, about 0.85<x<about 0.95, and about 0.90.

Also disclosed herein are devices comprising the (Ga₁₋ₓZnₓ)(N₁₋ₓOₓ) nanocrystals described herein. Such devices can split water and produce H₂, for example, a photoelectrochemical device.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. The accompanying figures, which are incorporated in and constitute a part of this specification, illustrate several aspects and together with the description serve to explain the principles of the invention.

FIG. 1 shows powder X-ray diffraction (XRD) patterns of the products of nitridation of a mixture of ZnGa₂O₄ and ZnO nanocrystals at varying reaction temperatures. The Zn content (x) in the starting material was 0.38, Reference patterns for cubic spinel ZnGa₂O₄ (JCPDS #38-1240), wurtzite ZnO (JCPDS #05-0664), and wurtzite GaN (JCPDS #2-1078) are shown as vertical lines. Assignments for the wurtzite peaks are also shown; (Inset) Values of x as a function of nitridation temperature. The x in the starting material in shown by the dotted line.

FIG. 2 shows the powder XRD patterns of (Ga₁₋ₓZnₓ)(N₁₋ₓOₓ) with varying values of x, synthesized at 650° C. Enlarged view of the wurtzite (100) peak shows a peak shift to ZnO with increasing x; (Inset) Lattice parameters a and c, determined from positions of (100) and (002) peaks respectively, showing deviations from ideal solid solution behavior represented by the blacklines. Lattice parameters could not be determined for the x=0.30 sample due to poor crystallinity.

FIGS. 3A, 3B, and 3C show aberration-corrected high-resolution transmission electron microscopy (HRTEM) images of 3 (Ga₁₋ₓZnₓ)(N₁₋ₓOₓ) nanoparticles, with fast Fourier transforms (FFTs) of each particle (insets). Particles are single-crystalline and lattice spacings can be indexed to the wurtzite d-spacings consistent with XRD patterns. Images and FFTs both show that the particles are single-crystalline.

FIG. 4 shows the absorption spectra of (Ga₁₋ₓZnₓ)(N₁₋ₓOₓ) with varying x, normalized at 380 nm. The absorption shifts continuously to longer wavelengths with increasing x. (Inset) Values of absorption onset as a function of x.

FIGS. 5A, 5B, 5C, and 5D show nanocrystalline starting materials for (Ga₁₋ₓZnₓ)(N₁₋ₓOₓ) synthesis. (a) Low resolution TEM image of ZnGa₂O₄nanocrystals. Size measurements on 311 particles showed that the average diameter was 3.6 nm with a standard deviation of 1.0 nm; (b) Low resolution TEM image of ZnO nanocrystals, which had an average diameter of 10.6 nm with standard deviation of 2.1 tun (392 particles measured); (c) Powder XRD pattern of ZnGa₂O₄nanocrystals, showing agreement with the literature pattern for cubic spinel ZnGa₂O₄(JCPDS #38-1240). Peaks are broad due to the small particle size. (d) Powder XRD pattern for ZnO nanocrystals, showing agreement with the JCPDS 405-0664 pattern for wurtzite ZnO.

FIG. 6A, 6B, 6C, and 6D show TEM images and size analysis of (Ga₁₋ₓZnₓ)(N₁₋ₓOₓ) nanocrystals with varying composition: (a) x=0.54; (b) x=0.66; (c) x=0.76; and (d) x=0.87. The average nanoparticles dimensions are about 18 nm in all four cases.

FIG. 7 is a photograph of nanocrystalline (Ga₁₋ₓZnₓ)(N₁₋ₓOₓ) samples with varying x showing a color change from yellow (brighter) to orange (darker) with increasing x. Powder XRD patterns of these samples are shown in FIG. 2 and diffuse reflectance spectra are shown in FIG. 3.

FIG. 8 graphically depicts the UV-vis absorption spectra of (Ga₁₋ₓZnₓ)(N₁₋ₓOₓ), where 0.3≦x≦0.98.

FIG. 9A shows various films of (Ga₁₋ₓZnₓ)(N₁₋ₓOₓ) and FIG. 9B shows an apparatus used to measure the anodic photo-current of the bulk sample (x0.22) and nano samples (x=0.42, 0.54, 0.66, and 0.76) to test the PEC response of these materials.

FIG. 10 graphically depicts the oxidation of sulfite ion (SO₃²⁻) in testing the oxidative ability of (Ga₁₋ₓZnₓ)(N₁₋ₓOₓ) films.

FIG. 11 graphically depicts the photocurrent from water oxidation.

FIG. 12 graphically depicts the reducing ability of the oxy(nitride) material without co-catalysts.

FIGS. 13A, 13B, 13C, and 13D are TEM images of (Ga₁₋ₓZnₓ)(N₁₋ₓOₓ) particles where the surface is decorated with co-catalyst.

FIG. 14 is a schematic representation of the co-catalyst coupled to the surface of (Ga₁₋ₓZnₓ)(N₁₋ₓOₓ) nanoparticles.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except in the examples, or where otherwise expressly indicated, all numerical quantities in this description indicating amounts of material or conditions of reaction and/or use are to be understood as modified by the word “about” in describing the broadest scope of the technology.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

A. Definitions

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

As used herein, the term “capping moiety” or the like terms refer to a chemical moiety linked to the surface of a particle. For example, 3-mercaptopropionic acid (MPA) linked to a nanocrystalline ZnGa₂O₄particle is a capping moiety,

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or can not occur, and that the description includes instances where said event or circumstance occurs and instances where it does not.

As used herein, the term “nitridation agent” or the like terms refer to a substance that can partake in the production a nitride. For example, NH₃ is a nitridation agent as it partakes in the production of the oxy(nitride) (Ga₁₋ₓZnₓ)(N₁₋ₓOₓ) once heated in the presence of nanocrystalline ZnGa₂O₄ and nanocrystalline ZnO.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

B. Compounds

Disclosed herein are various nanocrystals comprising (Ga_{1-X}Zn)(N_{1-X}O_{X}). Various forms of nanoscale (Ga₁₋ₓZnₓ)(N₁₋ₓOₓ) can have 0<x<1, about 0.125 <x <1, about 0.85<x<about 0.95, and about 0.90. In some embodiments, x is greater than 0.60 and less than 1.00. In one aspect, x can be greater than 0.80 or 0.85 and less than 1.00. In a further aspect, x can be 0.81-0.99, preferably x can be 0.85-0.95, and more preferably about 0.90.

In one aspect, the (Ga_{1-X}Zn)(N_{1-X}O_{X}) nanocrystal have an absorption edge from 2.7 to 2.2 eV. In a further aspect, the (Ga_{1-X}Zn)(N_{1-X}O_{X}) nanocrystal can have an absorption of about 2.7 eV, 2.6 e, 2.5 eV, 2.4 eV, 2.3 eV or 2.2 eV. In a further aspect, the (Ga_{1-X}Zn)(N_{1-X}O_{X}) nanocrystal can have an absorption edge of about 2.2 eV.

In one aspect, the (Ga_{1-X}Zn)(N_{1-X}O_{X}) nanocrystal can be less than 100 nm, 75 nm,50 rim, 40 nm, 30 nm, 25 nm, 20 nm, 15 nm, 10 nm, or 5 nm in diameter. In a further aspect, the (Ga_{1-X}Zn)(N_{1-X}O_{X}) nanocrystal can be less than 50 nm, 20 nm, or 15 nm in diameter. In a further aspect, the (Ga_{1-X}Zn)(N_{1-X}O_{X}) nanocrystal can be less than 15 nm in diameter.

In one aspect, the (Ga_{1-X}Zn)(N_{1-X}O_{X}) nanocrystal can be at least 5 nm, 10 nm, 15 nm, 20 nm, 25 nm, 50 nm, or 100 nm in diameter. In a further aspect, the (Ga_{1-X}Zn)(N_{1-X}O_{X}) nanocrystal can be at least 5 nm, 10 nm, 15 nm, or 20 nm in diameter. In a further aspect, the (Ga_{1-X}Zn)(N_{1-X}O_{X}) nanocrystal can be at least 10 nm in diameter.

In one aspect, the (Ga_{1-X}Zn)(N_{1-X}O_{X}) nanocrystal can be 5 nm-100 nm, 5 nm-50 nm, 5 nm-40 nm, 5 nm-30 nm, 5 nm-25 nm, 5 nm-20 nm, 5 nm -15 nm, or 5 nm-10 nm in diameter. In a further aspect, the (Ga_{1-X}Zn)(N_{1-X}O_{X}) nanocrystal can be 5 nm-25 nm, 5 nm-20 nm, or 5 nm-15 nm in diameter. In a further aspect, the (Ga_{1-X}Zn)(N_{1-X}O_{X}) nanocrystal can be 8 nm-25 nm, 8 nm-20 nm, or 8 nm-15 nm in diameter. In a further aspect, the (Ga_{1-X}Zn)(N_{1-X}O_{X}) nanocrystal can be about 5 nm, 10 inn, 15 nm, 20 nm, 25 nm, 30 nm, 40 nm, or 50 nm in diameter. In a further aspect, the (Ga_{1-X}Zn)(N_{1-X}O_{X}) nanocrystal can be about 10 nm, 15 nm, 20 nm, or 25 nm in diameter. In a further aspect, the (Ga_{1-X}Zn)(N_{1-X}O_{X}) nanocrystal can be about 10 nm in diameter.

In one aspect, the (Ga_{1-X}Zn)(N_{1-X}O_{X}) nanocrystal can have single-crystallinity. In one aspect, the (Ga_{1-X}Zn)(N_{1-X}O_{X}) nanocrystal can exhibit single-crystallinity properties. In one aspect, the (Ga_{1-X}Zn)(N_{1-X}O_{X}) nanocrystal can substantially have single-crystallinity.

In one aspect, the (Ga_{1-X}Zn)(N_{1-X}O_{X}) nanocrystal can comprise a co-catalyst. A co-catalyst can improve the water-splitting capabilities of a material. For example, (Ga_{1-X}Zn)(N_{1-X}O_{X}) nanocrystal with a co-catalyst could improve the quantum yields of water-splitting compared to a (Ga_{1-X}Zn)(N_{1-X}O_{X}) nanocrystal without a co-catalyst. In one aspect, the co-catalyst can comprise Rh_{2-y}Cr_{y}O₃wherein y is <2. In a further aspect, y can be about 0.5, 1.0, 1.5 or 1.8. In a further aspect, y can be about 1.5. Other suitable co-catalysts include, but are not limited to RuO₂/Cr₂O₃ (core/shell structures), NiO, NiO₂, RuO₂, CuO, Cu₂Cr₂O₅, CuO/Cr₂O₃, Rh/Cr₂O₃ (core/shell structure), Rh/Rh_{2-y}Cr_{y}O3, Pt, Pd, Pt/Cr₂O₃ (core/shell structure), and Pd/Cr₂O₃ (core/shell structure), or mixtures thereof.

It is contemplated that each disclosed derivative can be optionally further substituted. It is also contemplated that any one or more derivative can be optionally omitted from the invention. It is understood that a disclosed compound can be provided by the disclosed methods. It is also understood that the disclosed compounds can be employed in the disclosed methods of using.

C. (GA_{1-X}ZN)(N_{1-X}O_{X}) Nanocrystals Split Water

The utility of the compounds described herein includes facilitation of solar water splitting. The (Ga_{1-X}Zn)(N_{1-X}O_{X}) nanocrystals described herein convert water to H₂ in the presence of sun light or other suitable illumination sources. The band gap of the (Ga_{1-X}Zn)(N_{1-X}O_{X}) nanocrystals determines at what wavelength absorption occurs. For example, (Ga_{1-X}Zn)(N_{1-X}O_{X}) nanocrystals wherein x=0.9 have a band gap of 2.2 eV which translates that 565 nm can absorb resulting in the use of 15.3% of the solar photons. Band gap of 2.7 eV on the other hand translates to that 460 nm can absorb which is 5.8% of the solar photons. Accordingly, the (Ga_{1-X}Zn)(N_{1-X}O_{X}) nanocrystals described herein can be designed to maximize the efficiency of solar photon absorption.

D. Methods of Making the Compounds

Also disclosed herein are methods of synthesizing nanocrystals useful for splitting water to produce H₂.

In one aspect, the methods of synthesizing a nanocrystal comprising the steps of a) depositing nanocrystalline ZnGa₂O₄ and nanocrystalline ZnO in a heating device; and b) heating the deposited nanocrystalline ZnGa₂O₄ and nanocrystalline ZnO with a nitridation agent, wherein the nanocrystal comprises a (Ga_{1-X}Zn)(N_{1-X}O_{X}). Various forms of the nanocrystal (Ga₁₋ₓZnₓ)(N₁₋ₓOₓ) can have 0<x<1, about 0.125<x<1, about 0.85<x<about 0.95, and about 0.90. Other embodiments include where x is 0.30 to less than 1.00. In one aspect, x can be greater than 0.40, 0.50, 0.60, 0,70, 0.80 or 0.85 and less than 1.00. In a further aspect, x can be 0.81-0.99, preferably x can be 0.85-0.95, and more preferably about 0.90.

In one aspect, suitable nitridation agents include, but are not limited to, NH₃, such as anhydrous NH₃. Other suitable nitridation agents include, but are not limited to N₂H₂, ET₃N (triethyl amine), lithium hexamethyldisilazide (LiHDMS), Li₃N, Tris(trimethylsilyl)amine (N(TMS)₃), bis(trimethylsilyl)amine, hexamethyldisilazane (HMDS), NaNH₂, and NaN₃, and mixtures thereof. In one aspect, the nitridation agent can be in gaseous form. In a further aspect, the nitridation agent can have a flow rate. Suitable flow rates include, but are not limited to 50 ml/min, 100 ml/min, 120 ml/min, 150 ml/min and 200 ml/min. In a further aspect, the flow rate can be about 120 ml/min. In one aspect, the nitridation agent can be applied at a pressure. Suitable pressures include, but are not limited to, 1 atm, 1.5 atm, 2.0 atm, 2.5 atm, or 3.0 atm. In a further aspect, the nitridation agent can be applied at about 1 atm.

In one aspect, selecting a ratio of nanocrystalline ZnGa₂O₄ to nanocrystalline ZnO in the method determines the value of x in the (Ga_{1-X}Zn)(N_{1-X}O_{X}) nanocrystals at a heating temperature that does not evaporate Zn, such as 650° C. In one aspect, the composition can have a ratio of nanocrystalline ZnGa₂O₄ to nanocrystalline ZnO of at least 1:0, 1:3, 1:5, 1:7, 1:10, 1:17, 1:37, 1:63 and 1:199. In a further aspect, the composition can have a ratio of nanocrystalline ZnGa₂O₄ to nanocrystalline ZnO of at least 1:10, 1:17, 1:37, 1:63 and 1:199. A 1:10 ratio gives an x value of 0.33 while a 1:199 ration fives an x value of 0.99. Thus, by selecting such ratios of nanocrystalline ZnGa₂O₄ to nanocrystalline Zn, (Ga_{1-X}Zn)(N_{1-X}O_{X}) nanocrystals wherein x is between 0.33-0.99 can be produced. For example, when then ratios of nanocrystalline ZnGa₂O₄ to nanocrystalline Zn is 1:17 x is 0.90.

In one aspect, selecting a ratio of nanocrystalline Ga₂O₃to nanocrystalline ZnO in the method determines the value of x in the (Ga_{1-X}Zn)(N_{1-X}O_{X}) nanocrystals at a heating temperature that does not evaporate Zn, such as 650° C. In one aspect, the composition can have a ratio of nanocrystalline Ga₂O₃ to nanocrystalline ZnO of at least 1:0.01, 1:0.05, 1:0.1, 1:0.2, 1:0.3, 1:0.4, 1:0.5, 1:0.6, 1:0.7, 1:0.8, 1:0.9, 1:1, 1.1.1, 1:1.2, 1:1.3, 1:5, 1:10, 1:25, 1:50 and 1:100. In a further aspect, the composition can have a ratio of nanocrystalline Ga₂O₃ to nanocrystalline ZnO of at least 1:0.01, 1:1, 1:5, 1:10, 1:25, 1:50 and 1:100. A 1:0.01 ratio gives an x value of 0.01 while a 1:100 ratio fives an x value of 0.99. Thus, by selecting such ratios of nanocrystalline Ga₂O₃ to nanocrystalline Zn, (Ga_{1-X}Zn)(N_{1-X}O_{X}) nanocrystals wherein x is between 0.01-0.99 can be produced. For example, when then ratios of nanocrystalline Ga₂O₃to nanocrystalline ZnO is 1:1 x is 0.50.

In one aspect the heating can last for an extended period of time such as at least, 3 hrs, 5 hrs, 7.5 hrs, 10 hrs, 12.5 hrs or 15 hrs. The period of time can be determined based on the temperature of the heating. For example, shorter heating periods require higher temperature. In one aspect, the heating temperature can be about 500° C., 550° C., 600° C., 650° C., 700° C., 750° C., 800° C., or 850° C. In a further aspect, the heating temperature can be about 650° C. At this temperature, the Zn:Ga ratio in the starting material mixture can be maintained in the product. The (Ga₁₋ₓZnₓ)(N₁₋ₓOₓ) nanocrystals can have improved photoexcited carrier behavior, when compared to the bulk. For example, the (Ga₁₋ₓZnₓ)(N₁₋ₓOₓ) nanocrystals can have high quantum yields of water splitting, such as above 5%, 10%, 12%, or 15%, preferably above 10%, 12%, or 15%. In a further aspect, the heating temperature can be about 650° C. for about 10 hrs. In one aspect, the heating temperature and duration is selected to prevent evaporation of Zn, such as 650° C. for 10 hrs.

In one aspect, the (Ga_{1-X}Zn)(N_{1-X}O_{X}) nanocrystal can be less than 100 nm, 75 nm,50 nm, 40 nm, 30 nm, 25 nm, 20 nm, 15 nm, 10 nm, or 5 nm in diameter. In a further aspect, the (Ga_{1-X}Zn)(N_{1-X}O_{X}) nanocrystal can be less than 50 nm, 20 nm, or 15 nm in diameter. In a further aspect, the (Ga_{1-X}Zn)(N_{1-X}O_{X}) nanocrystal can be less than 15 nm in diameter.

In one aspect, the (Ga_{1-X}Zn)(N_{1-X}O_{X}) nanocrystal can be at least 5 nm, 10 nm, 15 nm, 20 nm, 25 nm, 50 nm, or 100 nm in diameter. In a further aspect, the (Ga_{1-X}Zn)(N_{1-X}O_{X}) nanocrystal can be at least 5 rim, 10 nm, 15 nm, or 20 rim in diameter. In a further aspect, the (Ga_{1-X}Zn)(N_{1-X}O_{X}) nanocrystal can be at least 10 mu in diameter.

In one aspect, the (Ga_{1-X}Zn)(N_{1-X}O_{X}) nanocrystal can be 5 nm-100 nm, 5 nm-50 nm, 5 nm-40 nm, 5 nm-30 nm, 5 nm-25 nm, 5 nm-20 nm, 5 nm-15 nm, or 5 nm-10 nm in diameter. In a further aspect, the (Ga_{1-X}Zn)(N_{1-X}O_{X}) nanocrystal can be 5 nm-25 nm, 5 nm-20 nm, or 5 nm-15 nm in diameter. In a further aspect, the (Ga_{1-X}Zn)(N_{1-X}O_{X}) nanocrystal can be 8 nm-25 nm, 8 nm-20 nm, or 8 nm-15 nm in diameter. In a further aspect, the (Ga_{1-X}Zn)(N_{1-X}O_{X}) nanocrystal can be about 5 nm, 10 nm, 15 nm, 20 nm, 25 nm, 30 nm, 40 nm, or 50 nm in diameter. In a further aspect, the (Ga_{1-X}Zn)(N_{1-X}O_{X}) nanocrystal can be about 10 nm, 15 nm, 20 nm, or 25 nm in diameter. In a further aspect, the (Ga_{1-X}Zn)(N_{1-X}O_{X}) nanocrystal can be about 10 nm in diameter.

In one aspect, the (Ga_{1-X}Zn)(N_{1-X}O_{X}) nanocrystal can have single-crystallinity. In one aspect, the (Ga_{1-X}Zn)(N_{1-X}O_{X}) nanocrystal can exhibit single-crystallinity properties. In one aspect, the (Ga_{1-X}Zn)(N_{1-X}O_{X}) nanocrystal can substantially have single-crystallinity.

In one aspect, the nanocrystalline ZnGa₂O₄ and nanocrystalline ZnO can be deposited from a dispersion or solution. In a further aspect, the nanocrystalline ZnGa₂O₄ and nanocrystalline ZnO can be deposited from a dispersion. In one aspect, the nanocrystalline ZnGa₂O₄ and nanocrystalline ZnO are mixed prior to heating. For example, the nanocrystalline ZnGa₂O₄ and nanocrystalline ZnO can be mixed prior to deposition. In a further aspect, the nanocrystalline ZnGa₂O₄ and nanocrystalline ZnO are deposited simultaneously from a single system, such as a dispersion or solution. In a further aspect, the nanocrystalline ZnGa₂O₄ and nanocrystalline ZnO are deposited individually.

In one aspect, the nanocrystalline ZnGa₂O₄ can comprise a capping moiety prior to heating, for example in the capping moiety can be present on the nanocrystalline ZnGa₂O₄prior to deposition. In a further aspect, the capping moiety can alter the hydrophobicity of the nanocrystalline ZnGa₂O₄. In a further aspect, the capping moiety can increase the solubility of the nanocrystalline ZnGa₂O₄.in polar solvents, such as water and ethanol. In one aspect, the capping moiety can comprise 3-mercaptopropionic acid (MPA).

In one aspect, the heating device can heat to at least 900° C. In a further aspect, the heating device can be a furnace, such as a tube furnace.

E. Compositions

Also disclosed herein is a compositions comprising the (Ga_{1-X}Zn)(N_{1-X}O_{X}) nanocrystals disclosed herein.

Also disclosed herein are compositions comprising nanocrystalline ZnGa₂O₄ and nanocrystalline ZnO. In one aspect, the composition can further comprise a nitridation agent. Suitable nitridation agents include, but are not limited to, NH₃, such as anhydrous NH₃, N₂H₂, ET₃N (triethyl amine), lithium hexamethyldisilazide (LiHDMS), Li₃N, Tris(trimethylsilyl)amine (N(TMS)₃), bis(trimethylsilyl)amine, hexamethyldisilazane (HMDS), NaNH₂, and NaN₃, and mixtures thereof. In one aspect, the nitridation agent can be in gaseous form. In a further aspect, the nitridation agent can have a flow rate. Suitable flow rates include, but are not limited to 50 ml/min, 100 ml/min, 120 ml/min, 150 ml/min and 200 ml/min. In a further aspect, the flow rate can be about 120 ml/min. In one aspect, the nitridation agent can be applied at a pressure. Suitable pressures include, but are not limited to, 1 atm, 1.5 atm, 2.0 atm, 2.5 atm, or 3.0 atm. In a further aspect, the nitridation agent can be applied at about 1 atm.

In one aspect, the nanocrystalline ZnGa₂O₄ or Ga₂O₃ can comprise a capping moiety. In a further aspect, the capping moiety can alter the hydrophobicity of the nanocrystalline ZnGa₂O₄ or Ga₂O₃. In a further aspect, the capping moiety can increase the solubility of the nanocrystalline ZnGa₂O₄ or Ga₂O₃ in polar solvents, such as water and ethanol. In one aspect, the capping moiety can comprise 3-mercaptopropionic acid (MPA). Other suitable capping moieties which increases hydrophobicity include but are not limited to oleic acid, long alkyl chained phosphonic acids, such as octadecylphosphonic acid, long alkyl chained amines, such as hexadecyl amine, thiols. Suitable capping moieties which increases hydrophilicity include but are not limited to thiostannates, halogen ions, and mercaphocarboxylic acids.

In one aspect, a composition comprising nanocrystalline ZnGa₂O₄, nanocrystalline ZnO and a nitridiation agent can produce (Ga_{1-X}Zn)(N_{1-X}O_{X}) nanocrystals upon heating, wherein x is greater than 0.30 and less than 1.00. In one aspect the heating can last for an extended period of time such as at least, 3 hrs, 5 hrs, 7.5 hrs, 10 hrs, 12.5 hrs or 15 hrs. The period of time can be determined based on the temperature of the heating. For example, shorter heating periods require higher temperature. In one aspect, the heating temperature can be about 500° C., 550° C., 600° C., 650° C., 700° C., 750° C., 800° C., or 850° C. In a further aspect, the heating temperature can be about 650° C. At this temperature, the Zn:Ga ratio in the starting material mixture can be maintained in the product. The (Ga₁₋ₓZnₓ)(N₁₋ₓOₓ) nanocrystals can have improved photoexcited carrier behavior, when compared to the bulk. For example, the (Ga₁₋ₓZnₓ)(N₁₋ₓOₓ) nanocrystals can have high quantum yields of water splitting, such as above 5%, 10%, 12%, or 15%, preferably above 10%, 12%, or 15%. In a further aspect, the heating temperature can be about 650° C. for about 10 hrs.

In one aspect, selecting a ratio of nanocrystalline ZnGa₂O₄to nanocrystalline ZnO determines the value of x in the (Ga_{1-X}Zn)(N_{1-X}O_{X}) nanocrystals at a heating temperature that does not evaporate Zn, such as 650° C. In one aspect, the composition can have a ratio of nanocrystalline ZnGa₂O₄ to nanocrystalline ZnO of 1:0, 1:3, 1:5, 1:7, 1:10, 1:17, 1:37, 1:63 and 1:199. In a further aspect, the composition can have a ratio of nanocrystalline ZnGa₂O₄to nanocrystalline ZnO of 1:10, 1:17, 1:37, 1:63 and 1:199. A 1:0 ratio gives an x value of 0.33 while a 1:199 ratio fives an x value of 0.99. Thus, by selecting such ratios of nanocrystalline ZnGa₂O₄ to nanocrystalline Zn, (Ga_{1-X}Zn)(N_{1-X}O_{X}nanocrystals, x can be defined as 0<x<1, about 0.125<x<1, about 0.85<x<about 0.95, and about 0.90. In certain aspects, an x value between 0.33-0.99 can be produced. For example, when the ratio of nanocrystalline ZnGa₂O₄to nanocrystalline Zn is 1:17, x is 0.90, and for x values below 0.3, increased temperatures are used.

In one aspect, selecting a ratio of nanocrystalline Ga₂O₃to nanocrystalline ZnO in the method determines the value of x in the (Ga_{1-X}(N_{1-X}O_{X}) nanocrystals at a heating temperature that does not evaporate Zn, such as 650° C. In one aspect, the composition can have a ratio of nanocrystalline Ga₂O₃to nanocrystalline ZnO of at least 1:0.01, 1:0.05, 1:0.1, 1:0.2, 1:0.3, 1:0.4, 1:0.5, 1:0.6, 1:0.7, 1:0.8, 1:0.9, 1:1, 1.1.1, 1:1.2, 1:1.3, 1:5, 1:10, 1:25, 1:50, and 1:100. In a further aspect, the composition can have a ratio of nanocrystalline Ga₂O₃ to nanocrystalline ZnO of at least 1:0.01, 1:1, 1:5, 1:10, 1:25, 1:50, and 1:100. A 1:0.01 ratio gives an x value of 0.01 while a 1:100 ratio fives an x value of 0.99. Thus, by selecting such ratios of nanocrystalline Ga₂O₃ to nanocrystalline Zn, (Ga_{1-X}Zn)(N_{1-X}O_{X}) nanocrystals wherein x is between 0.01-0.99 can be produced. For example, when the ratio of nanocrystalline Ga₂O₃to nanocrystalline ZnO is 1:1, x is 0.50.

F. Devices

Also disclosed herein are devices comprising the (Ga_{1-X}Zn)(N_{1-X}O_{X}) nanocrystals described herein. In one aspect, the device can produce H₂. In a further aspect, the device can split water to produce H₂. In a further aspect, the device can absorb at least 5%, 10%, 12.5%, or 15% of the solar photons. In one aspect, the device is a photoelectroehemical device. In another aspect, the device can be a photocatalytic device. In a photocatalytic device, H₂ and O₂ can be generated by mixing the nanocrystals disclosed herein with a solution and then illuminating the device.

G. Experimental

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric, in Boulder, CO (˜620 torr).

Several methods for preparing the compounds of this invention are illustrated in the following Examples. Starting materials and the requisite intermediates are in some cases commercially available, or can be prepared according to literature procedures or as illustrated herein.

The following exemplary compounds of the invention were synthesized. The Examples are provided herein to illustrate the invention, and should not be construed as limiting the invention in any way. The Examples are typically depicted in free base form, according to the IUPAC naming convention. However, some of the Examples were obtained or isolated in salt form.

As indicated, some of the Examples were obtained as racemic mixtures of one or more enantiomers or diastereomers. The compounds may be separated by one skilled in the art to isolate individual enantiomers. Separation can be carried out by the coupling of a racemic mixture of compounds to an enantiomerically pure compound to form a diastereomeric mixture, followed by separation of the individual diastereomers by standard methods, such as fractional crystallization or chromatography. A racemic or diastereomeric mixture of the compounds can also be separated directly by chromatographic methods using chiral stationary phases.

### 1. GENERAL METHODS

All chemicals were purchased from Sigma-Aldrich and used without further purification. All reactions were carried under atmospheric pressure, which is ˜620 torr in Boulder, Colo.

Powder X-ray diffraction (XRD) patterns were recorded with a Scintag X-2 X-ray diffractometer and a Scintag Pad V diffractometer, both equipped with Cu K< radiation (□=0.1540562 nm). Peak positions were determined by fitting with Lorentzian functions. Values of lattice constants a and c in wurtzite (Ga₁₋ₓZnₓ)(N₁₋ₓOₓ) were calculated from d-spacings of (100) and (002) peaks respectively. Crystallite size analysis was carried out using the Scherrer method⁵ using microcrystalline quartz XRD pattern to subtract instrumental broadening. Low-resolution transmission electron microscopy (TEM) was carried out using a Philips CM 100 microscope equipped with a bottom mounted 4 mega-pixel AMT v600 digital camera. Samples were prepared by drop casting from an ethanol suspension on carbon film, 300 mesh Cu grids (Electron Microscopy Sciences). High-resolution TEM imaging was carried out on an aberration-corrected FEI Titan 80-300 microscope at the CAMCOR facility at the University of Oregon. Samples were prepared by drop-casting on a lacey formvar film stabilized with carbon, 300 mesh Cu grids (Ted Pella, Inc.). Diffuse reflectance spectra were collected on a Shimadzu UV-3600 spectrophotometer, using BaSO₄ as a reflectance reference. Diffuse reflectance was converted to absorbance using the Kubelka-Munk equation (A=(1−R [symbol] )²/2R [symbol] ), where R [symbol] =Rₛₐₘₚₗₑ/R_{reference}. Elemental analysis by ICP-OES was carried out using ARL 3410+ inductively coupled optical emission spectrometer. The elemental analysis was sensitive to Zn and Ga, but not O and N. For comparison in Table 1, elemental analysis was also carried out by energy-dispersive X-ray spectroscopy (EDS), using a field emission scanning electron microscope (JEOL JSM-7401F),

Described below is a synthetic method that produces nanocrystals of (Ga₁₋ₓZnₓ)(N₁₋ₓOₓ) with a range of compositions (0.30<x<0.87). The methods include the use of nanocrystalline ZnGa₂O₄ and ZnO as precursors in varying ratios and convert them to the oxy(nitride) by exposure to NH₃. The required nitridation temperatures were lower than those needed for the synthesis of the bulk material, which allowed the nanoscale morphology to remain intact while producing high-quality crystals. The resulting materials were characterized by TEM, XRD, diffuse reflectance spectroscopy, and samples with x−0.76 were imaged by aberration corrected HRTEM. The dependence of lattice parameters on x was found to deviate from Vegard's law in agreement with theoretical predictions.¹² The band gaps of these visible absorbers decreased continuously with increasing x, from 2.7 eV for x=0.30 to 2.2 eV for x=0.87, The fraction of solar photons that can be absorbed increases by 260% over this range, demonstrating the solar water-splitting potential of ZnO-rich oxy(nitride) nanocrystals. The contrast with previously reported band gap bowing in bulk oxy(nitrides) synthesized at high pressures⁵ can be attributed to the formation of lower-density structures during nitridationreactions at atmospheric pressure.

### 2. EXAMPLE 1

### Synthesis of Nanocrystalline ZnGa₂O₄

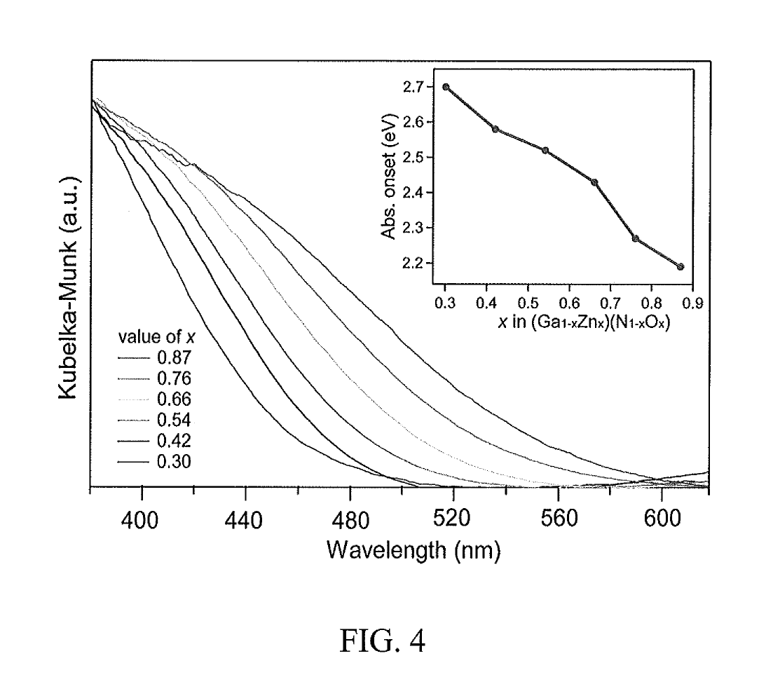

Synthetic procedure was adapted from a previous report by Byun, H. J. et al., (Nanotechnology 20(49), 495602 (2009)) which is hereby incorporated in its entirety by reference. 1 mmol of Zn(acac)₂ (99.995%), 2 mmol of Ga(acac)₃ (99.99%), 5 mmol of 1,2-hexadecanediol (90%), 6 mmol of oleic acid (≧99.0%) and oleylamine (70%), and 10 ml of benzyl ether (98%) were put in the three neck round bottom flask and heated to 40° C. under Ar. After the mixture became optically clear, the temperature was increased to 100° C. under vacuum to remove O₂ and H₂O. The temperature was then raised to 200° C. under Ar for 30 min. Sun, S. et al., (Journal of the American Chemical Society 2004, 126, 273-279) reported that this intermediate temperature step is critical for synthesis of uniformly sized spinel particles. The reaction was further heated to 280° C. and maintained at this temperature for 2 h. Upon cooling to room temperature, the resulting ZnGa₂O₄ nanocrystals were collected by centrifugation and purified three times by precipitation from 5 ml of hexane and 45 ml of ethanol. A TEM image of the nanocrystalline ZnGa₂O₄ is shown in FIG. 4A,

### 3. EXAMPLE 2

### Synthesis of Nanocrystalline ZnO

This synthesis was carried out following a previously reported procedure by Becheri, A., et al., (Journal of Nanoparticle Research 2008, 10, 679-689) which is hereby incorporated in its entirety by reference. 40 mmol of ZnCl₂(≧98%) was dissolved in 200 mL of 1,2-ethanediol (99.8%) at 150° C. under air. Upon reaching 150° C., 16 mL of 5 M NaOH solution was added dropwise (1 drop/second) to the above solution with stirring, while maintaining the reaction temperature at 150° C. After all the base was added (approximately 10 minutes), the solution was allowed to cool to room temperature. The resulting white powder was collected by sedimentation and the supernatant solution was discarded. The sedimentation was repeated five times in water to remove the NaCl from the product. The ZnO nanoparticles were collected by centrifugation and further purified three times with water. A TEM image of the nanocrystalline ZnO is shown in FIG. 4B.

### 4. EXAMPLE 3

### Ligand Exchange of Nanocrystalline ZnGa₂O₄

The ZnGa₂O₄nanocrystals were soluble in non-polar solvents, while the ZnO nanoparticles were hydrophilic. In order to produce uniform nanocrystal mixtures, ZnGa₂O₄ ligands were exchanged for 3-mercaptopropionic acid (3-MPA, ≧99.0%) (a capping moiety) by modification of a procedure by Amirav et al. (Journal of Physical Chemistry Letters 2010, 1, 1051-1054) which is hereby incorporated in its entirety by reference. 0.5 g of 3-MP A was dissolved in 3 ml of methanol and tetramethyl ammonium hydroxide (≧97%) was added to 3-MPA solution until pH reached 11. 60mg of ZnGa₂O₄ were dispersed in 3 ml of hexane and 15 ml of ethanol was added, which resulted in precipitation of ZnGa₂O₄. Then the basic 3-MPA solution was added to the ZnGa₂O₄/hexane/ethanol mixture with stirring. After the mixture became optically clear, 25 ml of toluene was added and the ligand-exchanged ZnGa₂O₄ was collected by centrifugation. After drying, particles were collected under vacuum, dissolved in 5 ml of water again and washed with 20 ml of ethanol and 25 ml of toluene by centrifugation.

### 5. EXAMPLE 4

### Synthesis of Nanocrystalline (Ga₁₋ₓZnₓ)(N₁₋ₓOₓ)

Mixtures of ZnO and MPA-capped ZnGa₂O₄nanocrystals (˜100 mg total) were dispersed in an approximately 1:1 water/ethanol mixture, deposited on a glass slide, and allowed to dry. Nitridation was carried out in a tube furnace (Lindberg Hevi-Duty) under an atmosphere of anhydrous NH₃ (99.99%, Airgas) for 10 hours, at temperatures ranging from 500 to 850° C. Furnace temperature was calibrated using a thermocouple device. The NH₃ flow rate was approximately 100 ml/min.

a. Characterization of Nanocrystalline (Ga₁₋ₓZnₓ)(N₁₋ₓOₓ)

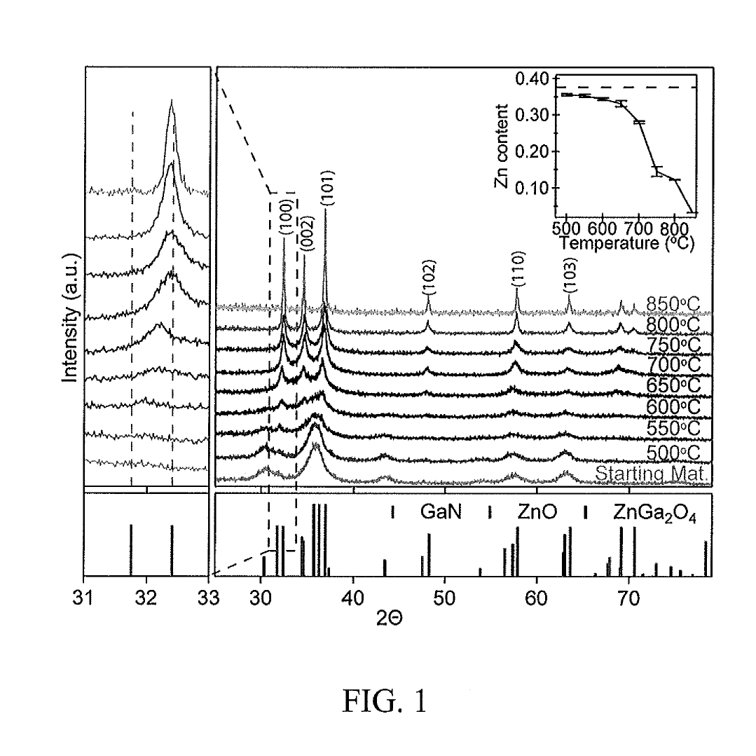

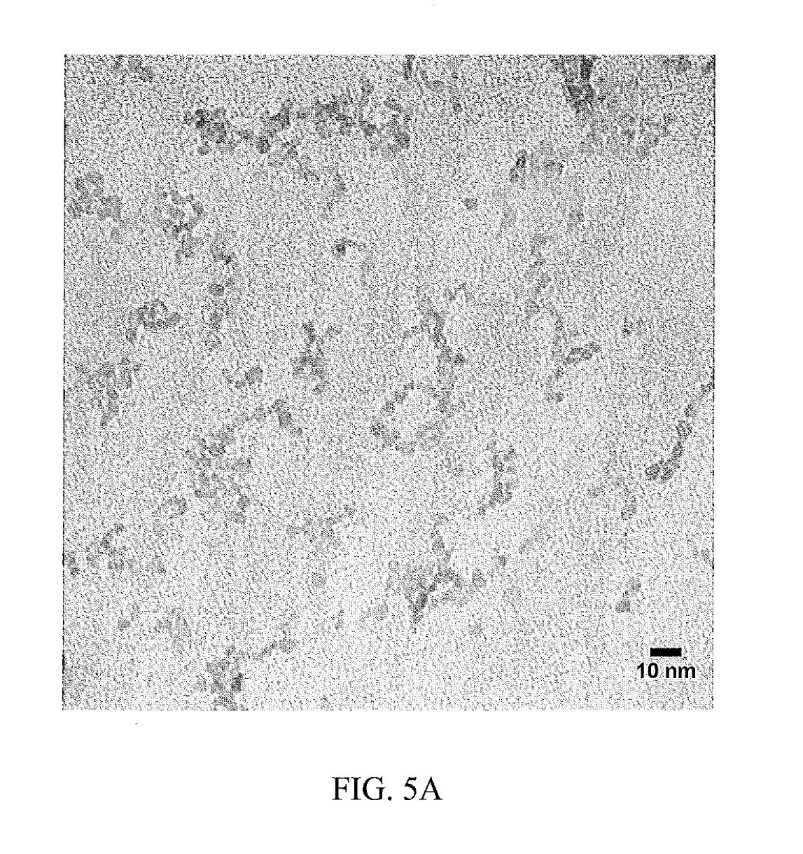

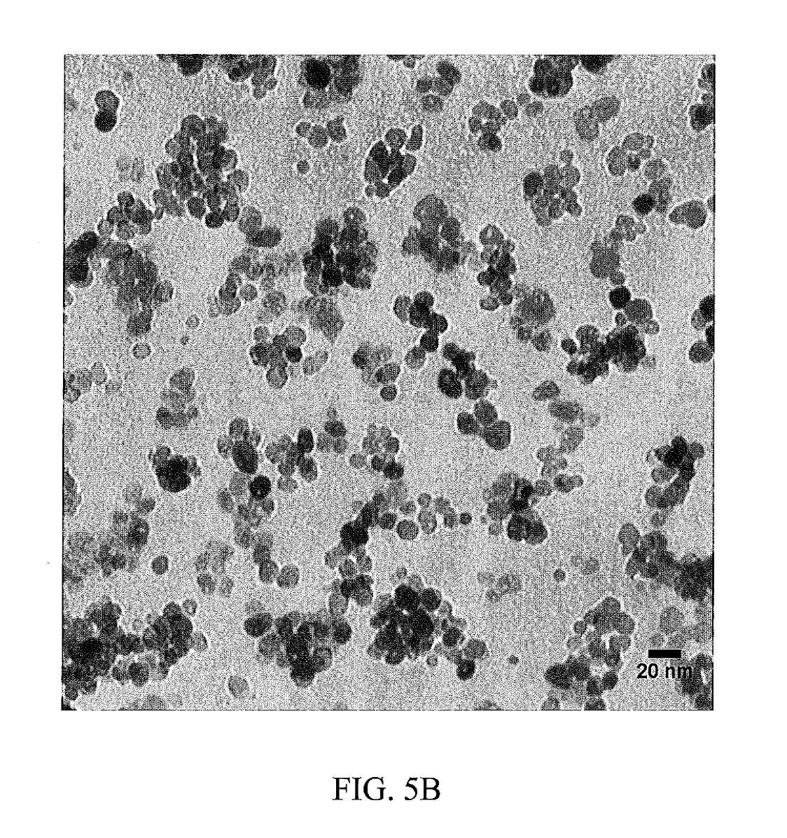

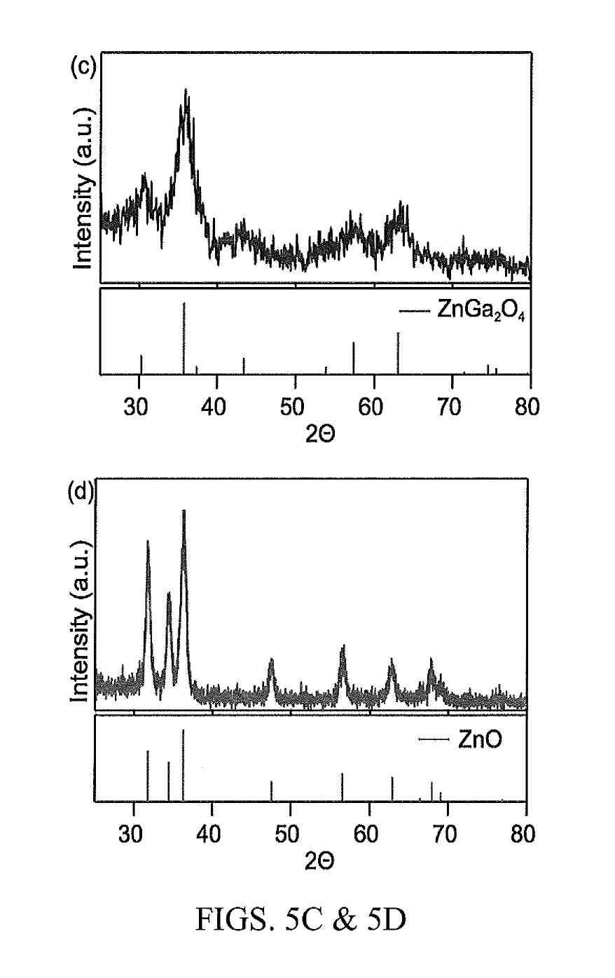

The diffuse reflectance spectra shown in FIG. 5 indicate a red shift of nitridation products up to 650° C. and a blue shift of nitridation products up to 750° C. This indicates a loss on Zn at higher temperatures which is consistent with the data in FIG. 1.

Table 1 shows the Elemental analysis for 650° C. nitridation with varying x. Comparison of x values in the starting materials and products indicates no appreciable loss of Zn. A comparison was also made between elemental analysis results obtained by ICP-OES and EDS techniques because many papers in the field report composition determined by EDS. The values of x obtained by the two techniques are similar. Standard deviations come from at least 3 measurements (ICP-OES)or at least 3 different spots on the SEM sample (EDS).

TABLE 1

| x in starting material | | |
|---|---|---|
| (ICP-OES) | x in product (ICP-OES) | x in product (EDS) |
| 0.30 ± 0.00 | 0.30 ± 0.00 | 0.31 ± 0.02 |
| 0.41 ± 0.00 | 0.42 ± 0.00 | — |
| 0.54 ± 0.00 | 0.54 ± 0.00 | 0.56 ± 0.01 |
| 0.65 ± 0.00 | 0.66 ± 0.00 | 0.73 ± 0.01 |
| 0.78 ± 0.00 | 0.76 ± 0.00 | 0.80 ± 0.00 |
| 0.89 ± 0.00 | 0.87 ± 0.00 | 0.90 ± 0.01 |

ZnGa₂O₄ nanocrystals had the diameters of 3.6 ±1.0 nm (FIG. 5A) and were soluble in organic solvents. The ZnO²⁷ particles were larger (d=10.6±2.1 nm) (FIG. 5C) and were dispersible in ethanol.

Low resolution TEM and size distribution analysis shows that the (Ga_{1-X}Zn)(N_{1-X}O_{X}) nanoparticles ranges in size from about 5 nm-40 nm with an average particle size of 18 nm (sd 5 nm).

(1) HRTEM Images of Nanocrystalline (Ga₁₋ₓZnₓ)(N₁₋ₓOₓ) (x=0.76)

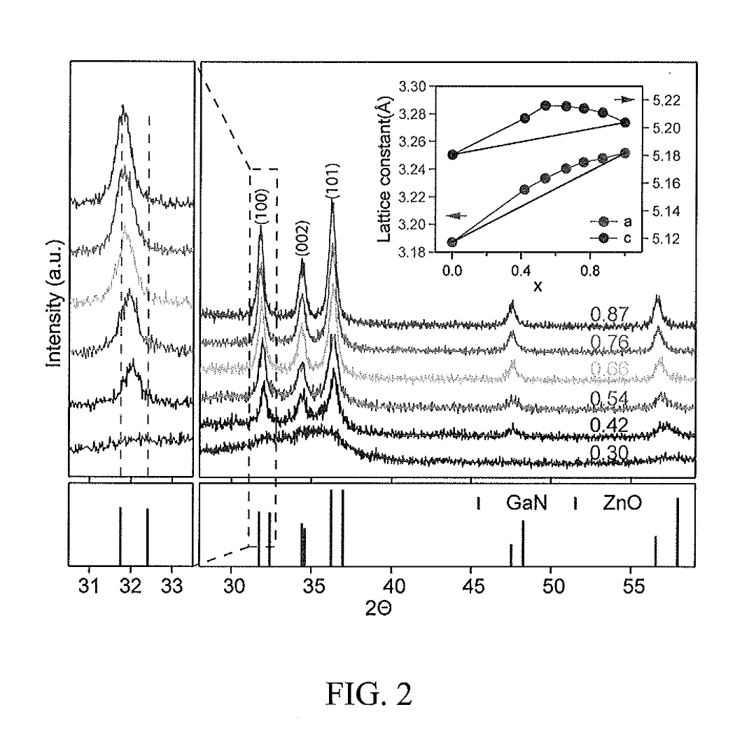

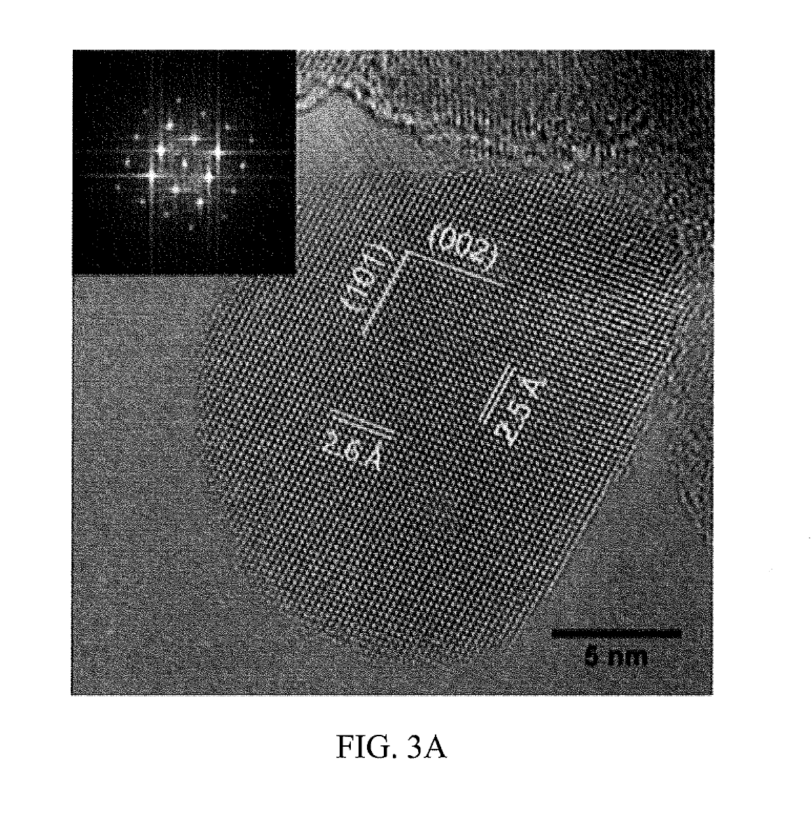

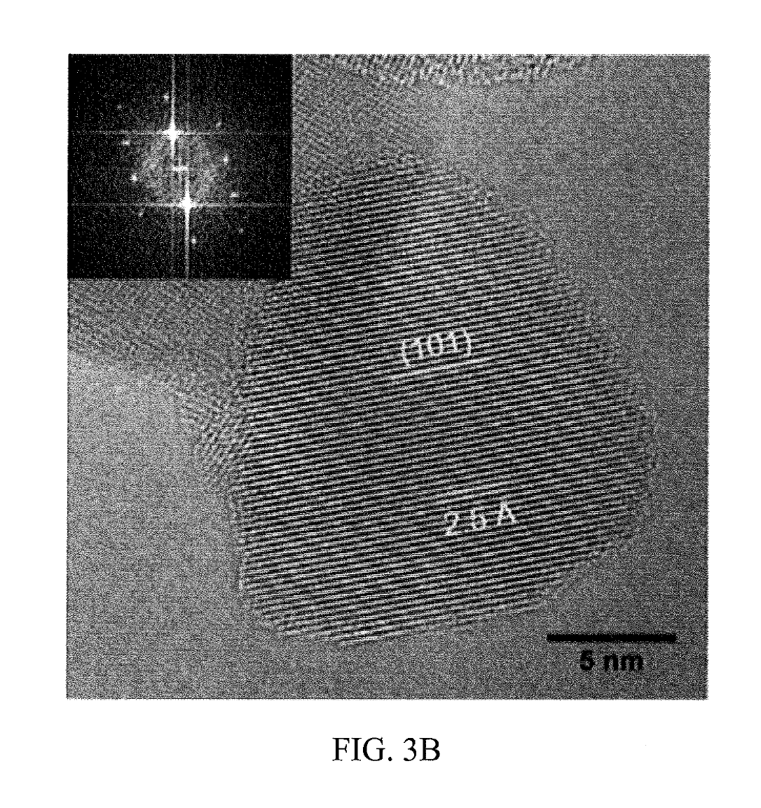

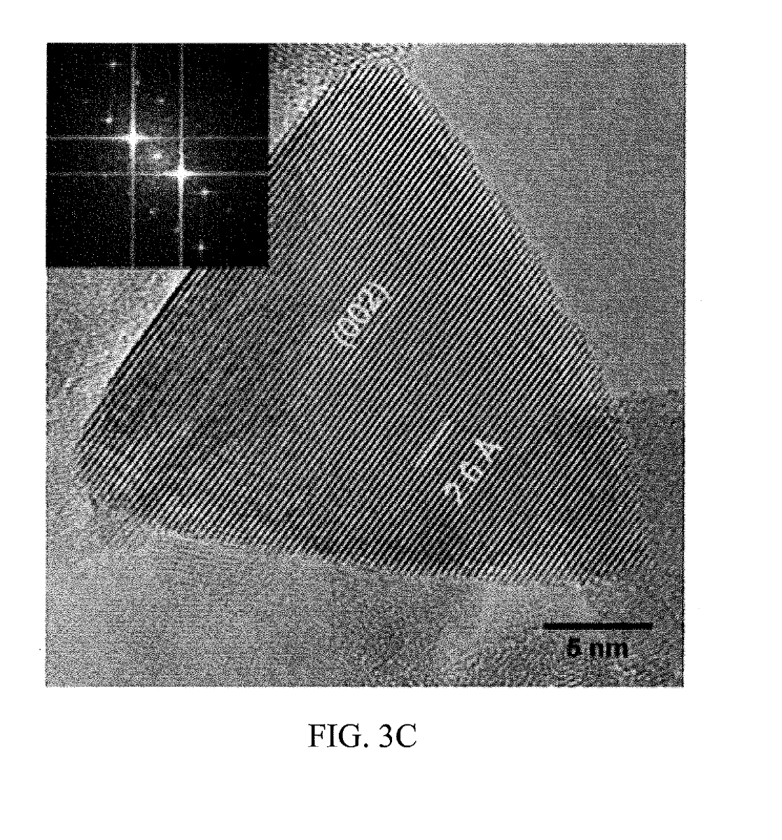

Example HRTEM images of oxy(nitride) nanoparticles with x=0.76 are shown in FIG. 3. The particles are single-crystalline, with dimensions of about 15 nm and non-uniform shapes. The lattice spacings of particles shown in FIG. 3 can be indexed to wurtzite, consistent with the XRD patterns (FIG. 2A). The data indicates that single crystallinity exist in these nanocrystals.

b. Particle Size and Composition Control Via Temperature

The optimal temperature for the synthesis of nanoscale (Ga₁₋ₓZnₓ)(N₁₋ₓOₓ) depends on the interplay of several competing factors. At relatively low nitridation temperatures, the chemical transformation of ZnGa₂O₄ and ZnO nanocrystals to the oxy(nitride) is slow because of a combination of insufficient energy to overcome the nitridation activation barrier and the slow diffusion of atoms both within and between nanocrystals. At relatively high temperatures, nanoparticles can fuse into the bulk form. Additionally, evaporation of Zn⁰ at high temperatures (˜900° C.) has plagued the commonly used bulk oxy(nitride) synthesis and limited the available x to <0.4.^{1-3, 29} The optimal temperature balances these factors, ideally allowing complete precursor transformation into the oxy(nitride) without loss of Zn, while maintaining nanoscale morphology.

Powder X-ray diffraction (XRD) patterns of the nitridation product as a function of temperature are shown in FIG. 1. Because longer reaction times can compensate for lower temperatures, all nitridations discussed here were carried out for 10 hours. The starting material was a mixture of cubic spinel ZnGa₂O₄ and wurtzite ZnO with Zn fraction (Zn/(Zn+Ga)) of 0.38, as determined by elemental analysis (ICP-OES) of acid-digested samples. At 500° C., the product XRD pattern is similar to that of the starting material. With increasing temperatures, increasing fractions of the wurtzite phases are observed, and cubic spinel phase is not detectable at temperatures 8650° C. This is most evident as the disappearance of the peak at 2*=43°. The enlarged view of the region around 2*=32° shows the appearance of the wurtzite (100) peak with increasing temperature. At 650° C., there is a relatively broad peak centered between ZnO and GaN (100) positions, and it shifts towards GaN at higher temperatures. This peak also narrows with increasing temperature, indicating an increase in the crystallite size. The XRD data indicates that the conversion to (Ga₁₋ₓZnₓ)(N₁₋ₓOₓ) is complete at 650° C., and higher temperatures lead to decreased Zn fraction. Elemental analysis of the nitridation products indeed shows a precipitous decline in Zn content at temperatures above 650° C. (FIG. 1 inset) due to the Zn⁰ evaporation described previously.^{2,23,29} The temperatures required for synthesis of bulk oxy(nitrides) by nitridation are typically higher (>800° C).^{1-4, 18} The chemical transformation of nanoscale precursors can be faster due to higher surface energies and relatively short atomic diffusion distances necessary to obtain oxy(nitride) nanocrystals.

Temperatures needed for successful nitridation were higher than the temperatures usually required to decompose organic species (<400° C.). Thus, the surface-capping moieties were not present in any of the final products, and the resulting particles were not soluble, though they could be dispersed in ethanol.

c. Control of Oxy(Nitride) Composition

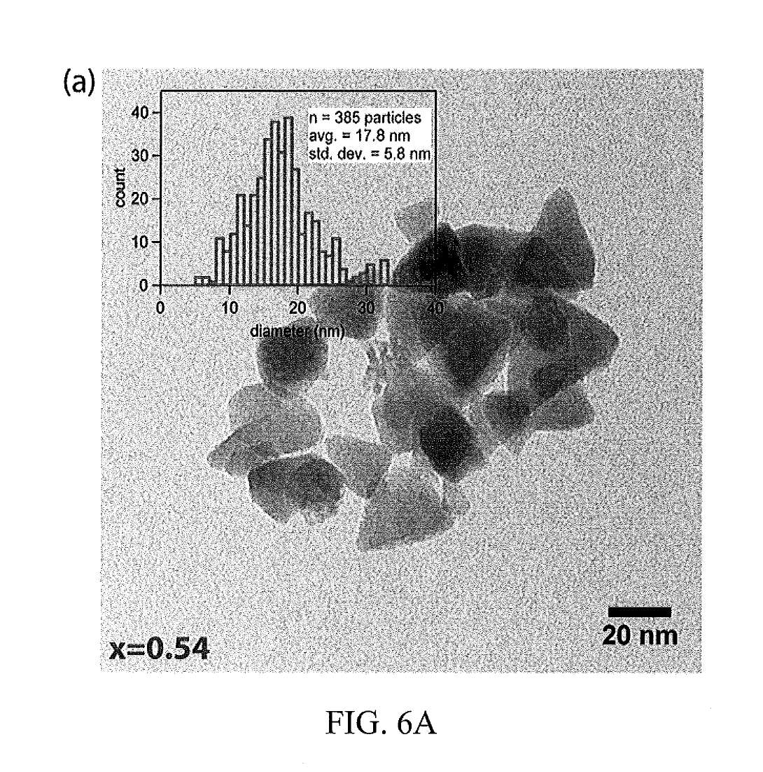

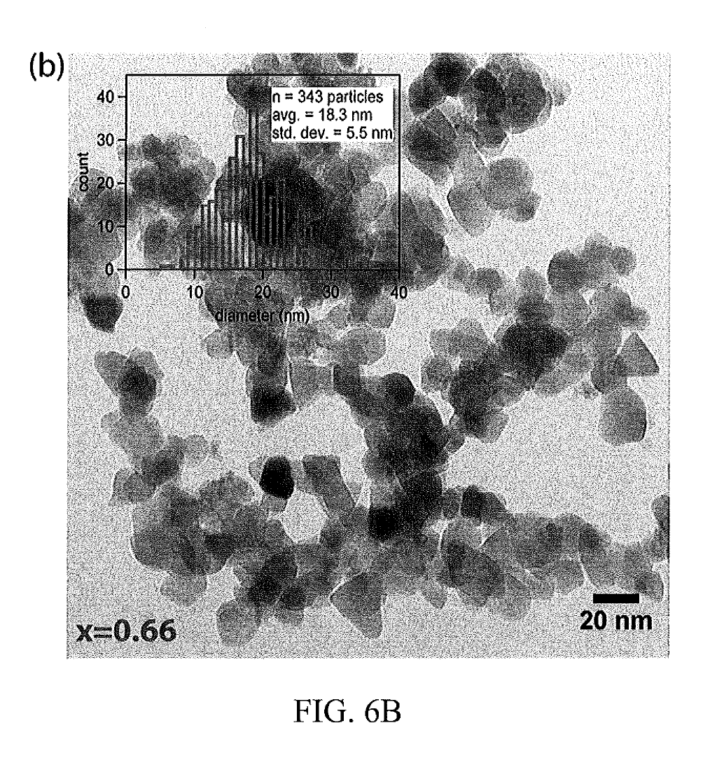

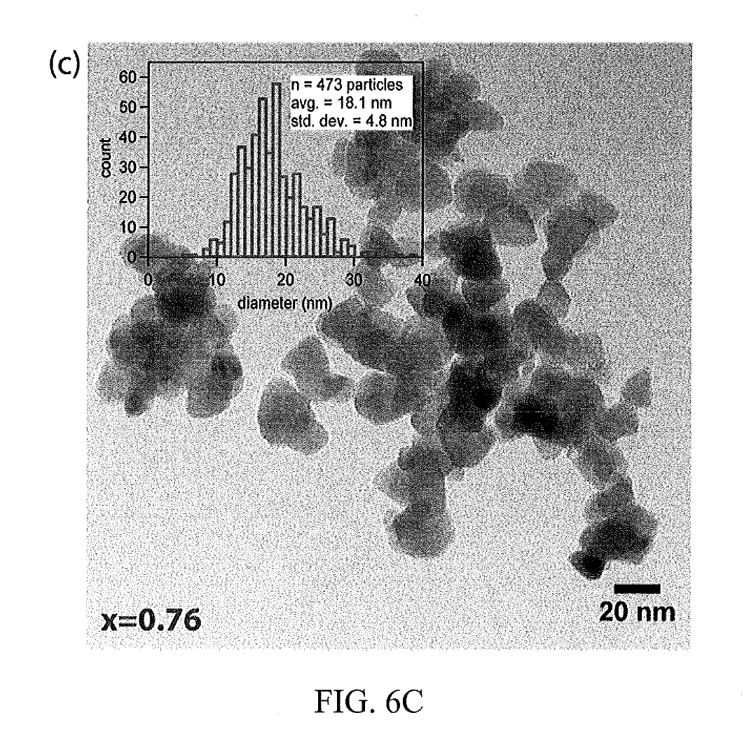

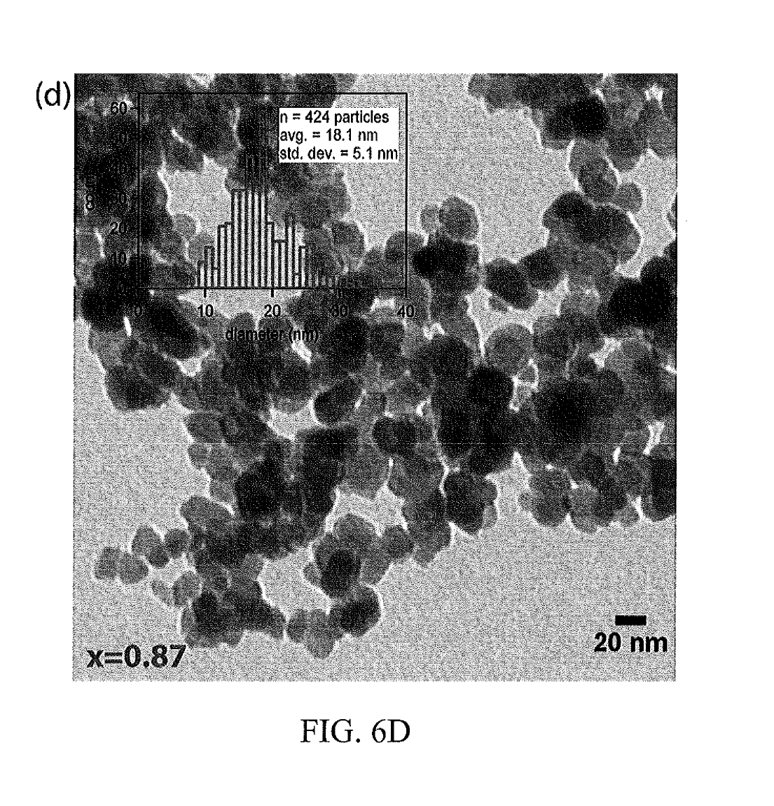

To obtain nanoscale (Ga₁₋ₓZnₓ)(N₁₋ₓOₓ) with a wide range of x, we combined nanocrystals of ZnGa₂O₄ and ZnO in varying ratios. The mixtures were then subject to nitridation at 650° C. for 10 hours. Values of x in starting materials and products were determined by ICP-OES of acid-digested samples (Table 1). No significant loss of Zn during nitridation was observed. TEM images of nanoparticles with x=0.54, 0.66, 0.76, and 0.87, and corresponding size analysis, are shown in FIG. 6. The particles appear faceted and reminiscent of hexagonal-cone shaped ZnO nanocrystals.³⁰ Particle sizes remain constant over the composition range, with dimensions around 18 nm and standard deviations around 5 nm. In this size regime, we do not expect to observe effects of quantum confinement because the exciton Bohr radii in ZnO and GaN are <5 nm,

XRD patterns of nanoscale (Ga₁₋ₓZnₓ)(N₁₋ₓOₓ) with x ranging from 0.30 to 0.87 are shown in FIG. 2. The product with x=0.30 exhibits poor crystallinity for reasons not fully understood. It was also observed in bulk oxy(nitrides) that addition of ZnO to the starting material improved product crystallinity and photocatalytic activity, even though the remaining Zn fraction was <0.3, but the reason for this improvement is not known.³¹ An enlarged view of the (100) wurtzite peak in the XRD patterns (FIG. 2) shows that the peak position shifts away from GaN and toward ZnO with increasing x. The variation of lattice constants a and c, determined from positions of (100) and (002) XRD peaks respectively, is shown in the inset of FIG. 2. Both lattice constants deviate from the linear ideal solid solution behavior described by Vegard's law. Similar deviations were predicted theoretically for bulk (Ga₁₋ₓZnₓ)(N₁₋ₓOₓ), and were attributed to bond distortions that arise because of the nonisovalent nature of the solid solution.¹² The deviations in FIG. 2 are also similar, though somewhat higher in magnitude, to those seen in bulk (Ga₁₋ₓZnₓ)(N₁₋ₓOₓ) made by mixing of ZnO and GaN under high pressures (up to 6.2 GPa) and temperatures (>700° C).⁵ One major difference is the lattice constant c for materials with approximately equal amounts of ZnO and GaN: in the bulk, the x=0.49 was closer to the value for the ideal solid solution than the GaN-rich and ZnO-rich samples, while in FIG. 2, x=0.54 is the furthest from the ideal value. This contrast implies that the chemical bonds in the c direction in x˜0.5 samples are relatively long in our materials and relatively short in those obtained by high-pressure mixing of ZnO and GaN powders, indicating structural differences and possibly even different phases of the material in the two experiments. The atomic level structure of (Ga₁₋ₓZnₓ)(N₁₋ₓOₓ), including the nature of the local chemical bonding, and the balance between the enthalpic cost of mixed valence and the entropic benefit of mixing, is not yet understood.^{5, 6, 10, 12-14, 32, 33} The differences in the reaction pressures can account for the longer bond-lengths as observed here: high-pressure conditions generally favor higher-density phases, while the atmospheric-pressure nitridation described here produces a more expanded lattice, especially in the x˜0.5 case. There may also be additional differences in pressure response due to the nanoscale size regime³⁴.

d. Particle Crystallinity

The crystalline quality of the materials described here are for samples with x=0.76. Aberration-corrected HRTEM images of three particles are shown in FIG. 3. The particles are single-crystalline and their lattice spacing's can be indexed to wurtzite, consistent with the XRD patterns (FIG. 2). Crystallite size analysis by the Scherrer method³⁵ is consistent with the nanoparticle sizes measured from low-resolution TEM images (FIG. 6c), indicting that most of these (Ga₁₋ₓZnₓ)(N₁₋ₓOₓ) nanoparticles are singlecrystalline. The high quality of the nanocrystals is promising for achieving improved watersplitting quantum yields because of the decreased probability of energy-wasting internal carrier trapping and recombination processes.

e. Optical Spectra as a Function of Composition

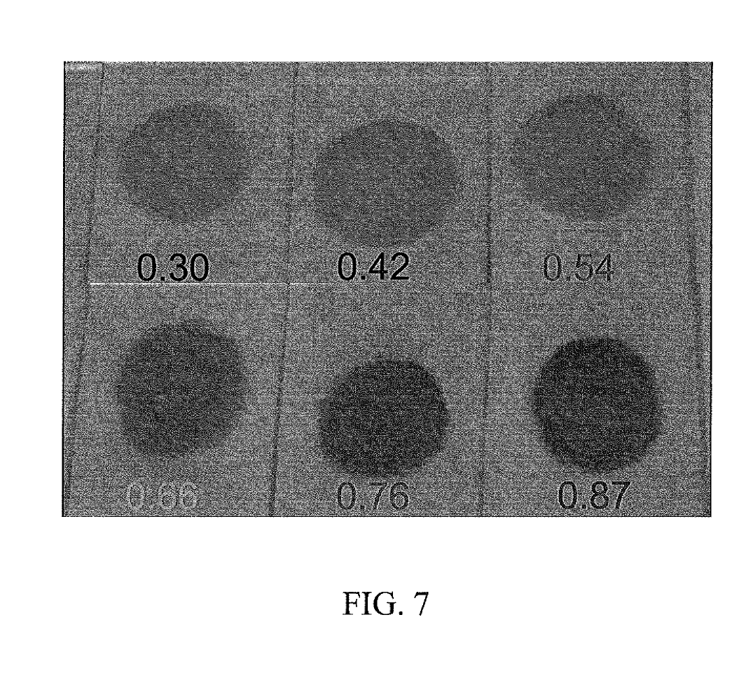

The ability to control x in (Ga₁₋ₓZnₓ)(N₁₋ₓOₓ) nanocrystals allowed for tuning their absorption spectra, as shown in FIG. 4. The spectra were obtained by conversion of diffuse reflectance to absorbance using the Kubelka-Munk function. Images of the samples (FIG. 7) shows the gradual change of color from yellow (brighter in figure) to orange (darker in figure). The origin of the visible absorption in (Ga₁₋ₓZnₓ)(N₁₋ₓOₓ) is not well understood:⁵⁻¹⁶ Both band-gap bowing and the improved band-gap lowering in ZnO-rich oxy(nitrides) have been predicted by theoretical studies.^{7, 9, 10, 12} No assumptions were made about the direct or indirect nature of the visible absorption, and therefore the absorption onset values were reported, determined by linear extrapolation of the absorption edge to zero absorbance (FIG. 4 inset).³⁶ The absorption onset shifts to the red almost linearly from 460 nm (2.7 eV) for x=0.30 to 565 nm (2.2 eV) for x=0.87. This observation is in contrast to the case of bulk (Ga₁₋ₓZnₓ)(N₁₋ₓOₓ) synthesized by mixing of ZnO and GaN powders under high pressure and temperature, which exhibited band gap bowing with the minimum gap at x=0.49 (2.5 eV).⁵ Instead, the results shown herein agree with the observation for bulk (Ga₁₋ₓZnₓ)(N₁₋ₓOₓ) synthesized by nitridation of layered double hydroxides, which had red-shifting absorption onsets over the range 0.5<x<0.8, to values as low as 2.4 eV.¹⁸ This qualitatively different behavior can be attributed to the structural differences between the high-pressure oxy(nitrides) and those obtained under atmospheric pressure, described above. These results demonstrate that achieving ZnO-rich compositions of nanoscale oxy(nitrides) is an viable strategy for band gap lowering.

The ability to synthesize oxy(nitride) nanocrystals with high ZnO content and low band gaps has important practical implications. Because the solar photon flux rises sharply across the 300-550 nm range, relatively small differences in absorption onsets in this region can significantly impact the solar-harvesting capacity of a material. A semiconductor with a band gap of 2.7 eV can absorb 5.8% of terrestrial solar photons, while one with a band gap of 2.2 eV can absorb 15.3%.³⁷ Thus, a shift in the absorption onset between our x=0.30 and x=0.87 samples increases the fraction of solar photons absorbed by a factor of 2.6. This increase would translate to, if the quantum yields of water splitting were otherwise equal (i.e., if the shifted band edges still had proper over potentials for water splitting), that 260% more H,that could be produced by the same amount of material under identical solar irradiation.

The examples demonstrate the synthesis and characterization of high-quality (Ga₁₋ₓZnₓ)(N₁₋ₓOₓ) nanocrystals over a broad range of compositions, 0.30<x<0.87. Control of x was achieved by nitridation of nanocrystalline ZnGa₂O₄ and ZnO precursors in varying ratios. Use of nanoscale precursors and relatively low nitridation temperatures prevented both the formation of bulk oxy(nitride) and the evaporation of Zn, and produced high-quality nanocrystals. Over the range of compositions studied, the absorption onset decreased monotonically from 23 to 2.2 eV with increasing x, which corresponds to a 260% improvement is solar photon absorption,

### 6. EXAMPLE 5

### Further Synthesis of Nanocrystalline (Ga₁₋ₓZₓ)(N₁₋ₓOₓ)

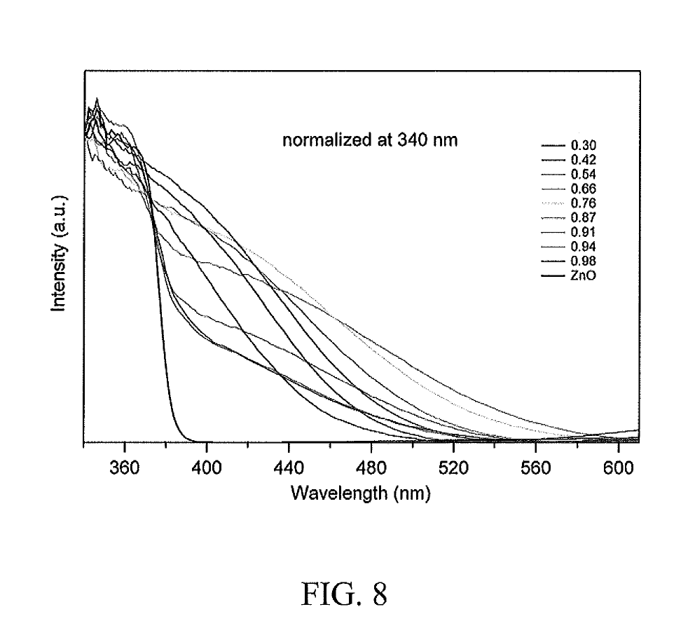

Synthesis of nanoscale (Ga_{1-X}Zn_{X})(N_{1-X}O_{X}) has been extended to expand the x values to 0.3<x<1. FIG. 8 shows the UV-vis absorption spectra of the (Ga₁₋ₓZnₓ)(N₁₋ₓOₓ), (0.3≦x≦0.98). All samples were obtained by nitridation of the mixture of ZnGa₂O₄ and ZnO at 650° C. for 10 hours. It was observed the absorption onset of the samples increased with x until 0.87. However, the opposite trend was observed after 0.87 that the absorption onset decreased back with x. The composition and band gap values are listed in Table 2 below.

TABLE 2

| Composition | Absorption onset (nm) | Absorption onset (band gap) (eV) |
|---|---|---|
| 0.30 | 460 | 2.7 |
| 0.42 | 480 | 2.6 |
| 0.54 | 492 | 2.5 |
| 0.66 | 510 | 2.4 |
| 0.76 | 546 | 2.3 |
| 0.87 | 565 | 2.2 |
| 0.91 | 530 | 2.3 |
| 0.94 | 510 | 2.4 |
| 0.98 | 510 | 2.4 |

At the low x range, x values as low as 0.125 can be obtained by increasing the reaction temperature to 750° C. Particle size characterization for x=0.2 shows nano-sized particles. Using small increases in temperature, one can achieve still lower values of x while maintaining nano size. For example, x values can approach values close to zero, or about 0.02 in certain embodiments, where the material can be expected to form nanoscale (Ga₁₋ₓZnₓ)(N₁₋ₓOₓ). Too much heat, however, can result in the formation of bulk material. Nanoscale (Ga₁₋ₓZnₓ)(N₁₋ₓOₓ) can therefore be formed having x values defined as 0<x<1, about 0.125<x<1, about 0.85<x<about 0.95, and about 0.90.

a. Photo-Electrochemical (PEC) Properties

Photoelectrochemical (PEC) measurements allow measurement of the efficiency of photo-oxidation by films of nano-oxy(nitrides). The details are described below. The main result is that nanoscale oxy(nitrides) perform better than the bulk material (with x=0.22).

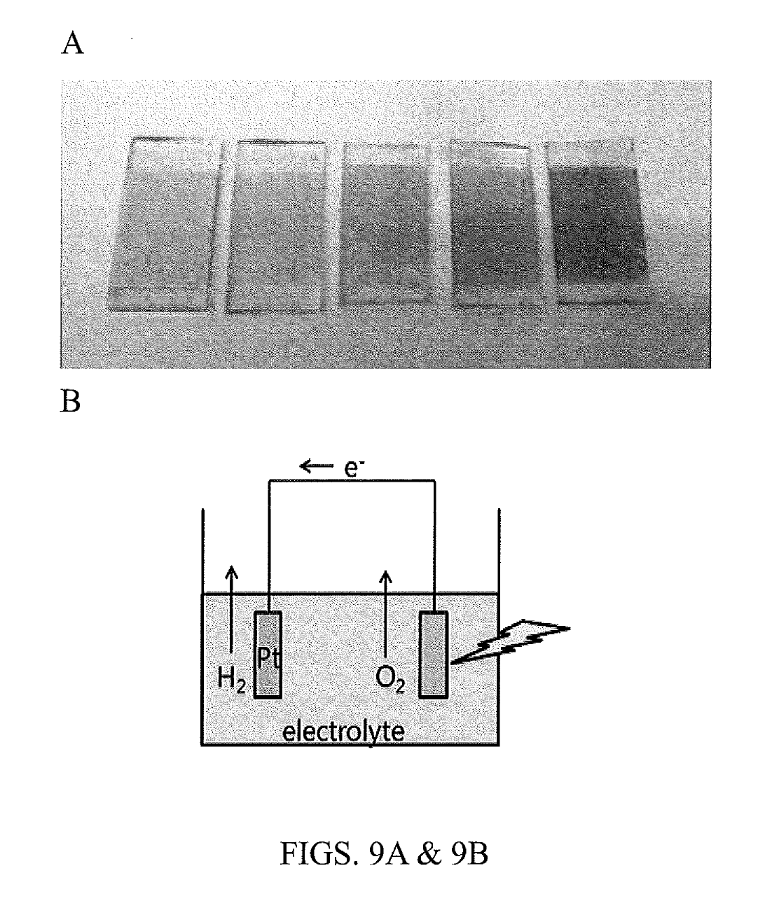

Fabrication of films: 0.1 g of ethylcellulose and 10 mL of α-terpeniol were mixed thoroughly, and it was added to 10 mg of (Ga₁₋ₓZnₓ)(N₁₋ₓOₓ) and mixed together to form a paste. The prepared paste was applied onto the FTO of which edges were covered with tape. The paste on the FTO was flattened with a razor blade by scrapping out excess paste over the tape so the film thickness can be determined by the thickness of the tape. The film was dried at 100° C. for 1 hour after removing the tape. See FIG. 9A.

PEC response was tested by measuring the anodic photo-current with the bulk sample (x=0.22) and nano samples (x=0.42, 0.54, 0.66, and 0.76). It was performed under 300 Watt Xe-arc lamp that were calibrated with a reference cell (GaNP) for the intensity of AM 1.5 G, and 435 nm long pass filter was introduced to cut off the UV light from the lamp. Three electrodes system was used with a working electrode, Ag/AgCl (3 M KCl) reference electrode, and platinum cathode. The photocurrent was measured with chopping the light source while sweeping the potential to the positive direction. See FIG. 9B.

For the oxidation of SO₃²⁻, pH 7 phosphate buffer solution with 0.1 M Na₂SO₃ was used as an electrolyte, while pH 7 phosphate buffer solution with 0.1 M K₂SO₄ was used for a water oxidation.

1) Oxidation of Sulfite Ion (SO₃²⁻)

Sulfite ion is a strong hole scavenger and can be oxidized kinetically faster than water oxidation. Thus, oxidation of sulfite ion is generally carried out to test the oxidative ability of films.

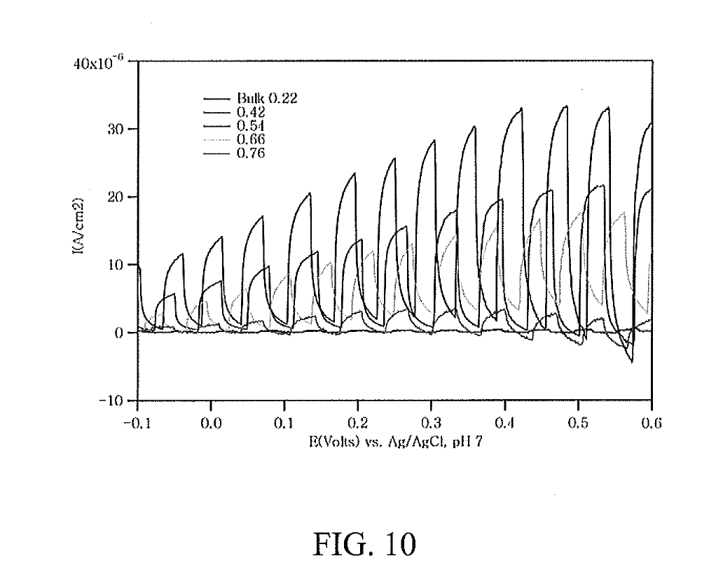

It was observed for every sample that the photocurrent increased with sweeping the potential to the positive direction, indicating that (Ga₁₋ₓZnₓ)(N₁₋ₓOₓ) is n-type semiconductor. As an n-type semiconductor, (Ga₁₋ₓZnₓ)(N₁₋ₓOₓ) films act as an anode and generate the anodic photocurrent. The bulk 0.22 film shows very tiny chopping signal, while the nano samples showed observable photocurrent. The photocurrent increase with x until 0.54, and it decreased back after 0.54. Results are shown in FIG. 10.

2) Photocurrent from Water Oxidation

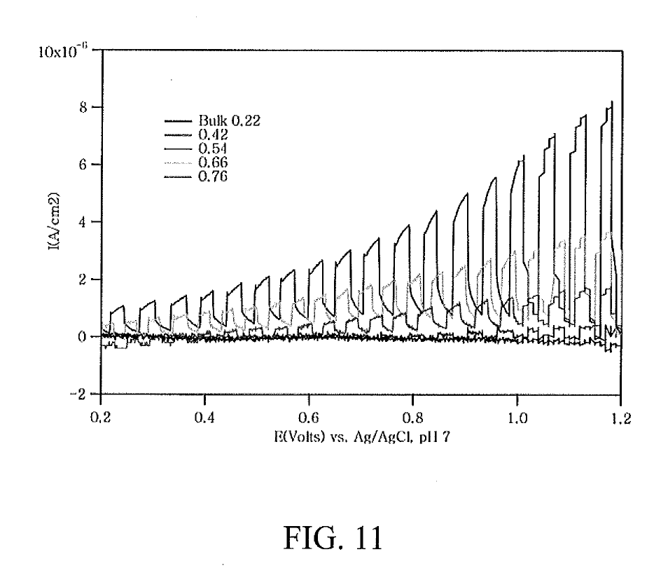

FIG. 11 shows the photocurrent from actual water oxidation. Like oxidation of sulfite ion, it was observed that 0.54 showed the highest photocurrent density of 2.6 μA/cm² at the thermodynamic potential for water oxidation, 0.618 V vs. Ag/AgCl at pH 7 (=1.23 V vs. RHE). This water oxidation shows the photocurrent several times less than sulfite oxidation. The enhancement of photocurrent in the presence of sulfite says that the water oxidation is limited by its poor kinetics, which is normal and expected for such a complicated multi-electron transfer reaction.

3) Photochemical Reduction by Nano-Oxy(Nitrides)

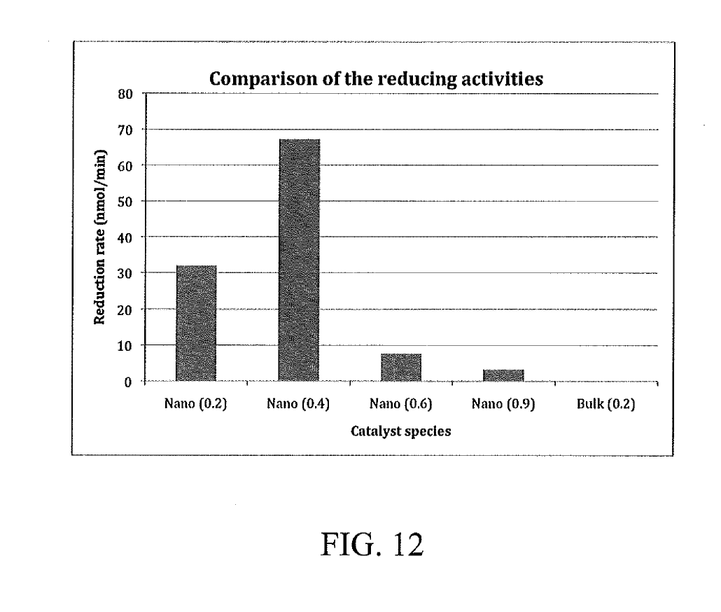

To test the ability of the nano-oxynitrides to perform reduction, we measured reduction efficiency for methyl viologen. Methyl viologen reduction is a one-electron reaction and should tell us about the inherent properties of the photocatalyst. In previous work by Domen, it was observed that for proton reduction (H₂ generation) required the use of co-catalyst, which adds an additional complication. Thus, we first examined the reducing ability of the oxy(nitride) material without co-catalysts. As shown in FIG. 12, nano(oxy-nitrides) with various compositions performed much better than the bulk oxy(nitride) materials. The composition (value of x) is shown in parentheses.

4) Modification of (Ga₁₋ₓZnₓ)(N₁₋ₓOₓ) with Co-Catalyst

Various procedures can be used for functionalizing the nano-oxy(nitrides) with H₂ production co-catalyst. One such procedure includes the following:

a. Amine functionalized (Ga₁₋ₓZnₓ)(N₁₋ₓOₓ): 200 mg of (Ga₁₋ₓZnₓ)(N₁₋ₓOₓ) (x=0.76) was dispersed in 10 ml of toluene, and 0.1 ml of APTES (aminopropyltriethoxysilane) was added. The reaction mixture was refluxed for 6 hours, and washed with ethanol by centrifugation to remove unreacted APTES. The resulting product was dried under vacuum.

b. Deposition of Rh co-catalyst on (Ga₁₋ₓZnₓ)(N₁₋ₓOₓ): 100 mg of amine functionalized (Ga₁₋ₓZnₓ)(N₁₋ₓOₓ) was dispersed in 20 ml of water, and 10 mg of NaRhCl₃ was added. The reaction mixture was stirred for 6 hours at room temperature to form Rh-amine pairs, then washed with water by centrifugation to remove excess rhodium precursor. After drying the resulting product under vacuum, it was annealed under argon at 250° C. for 1 hour to reduce and deposit the rhodium particle on (Ga₁₋ₓZnₓ)(N₁₋ₓOₓ).

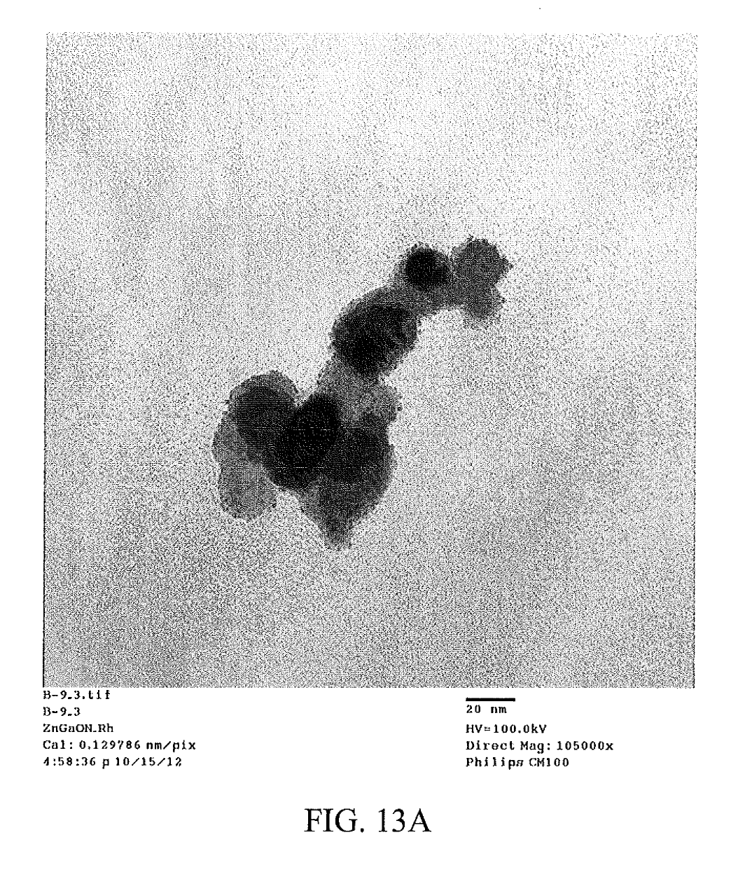

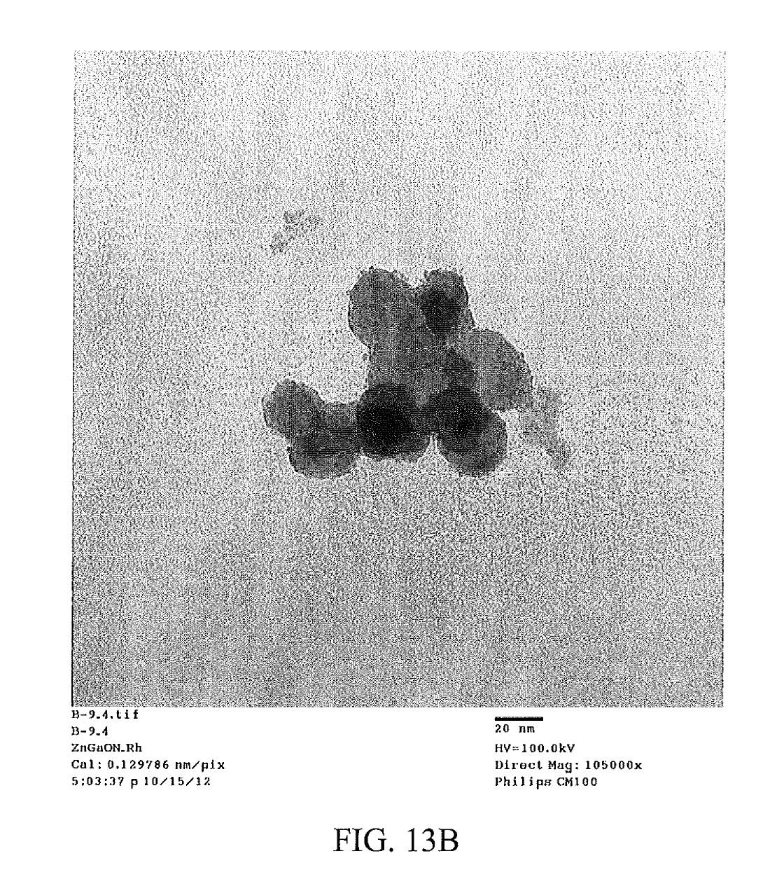

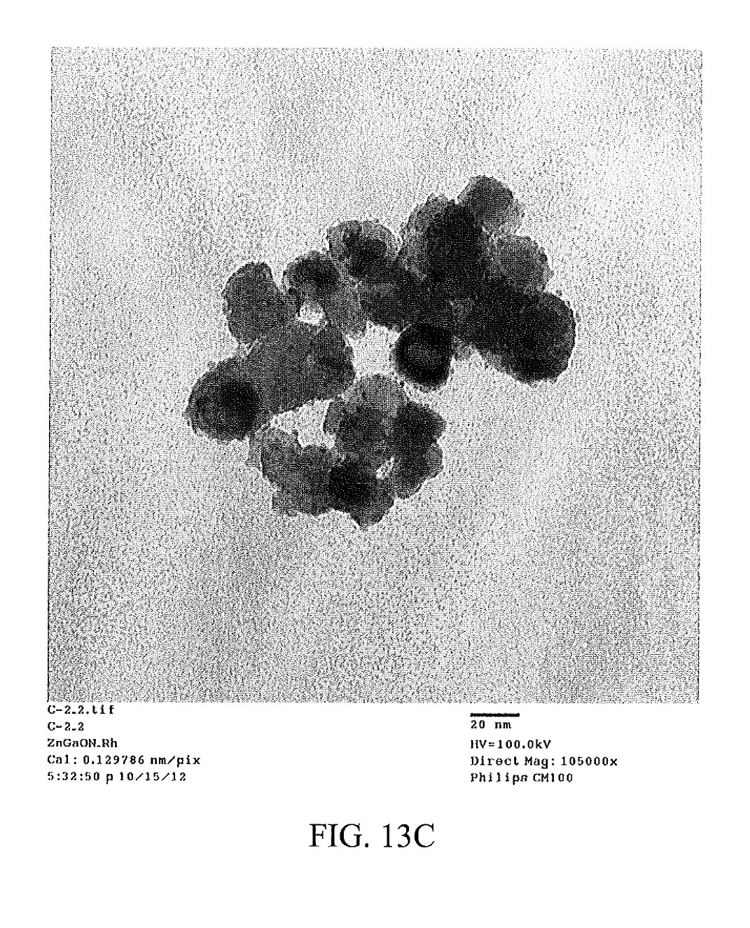

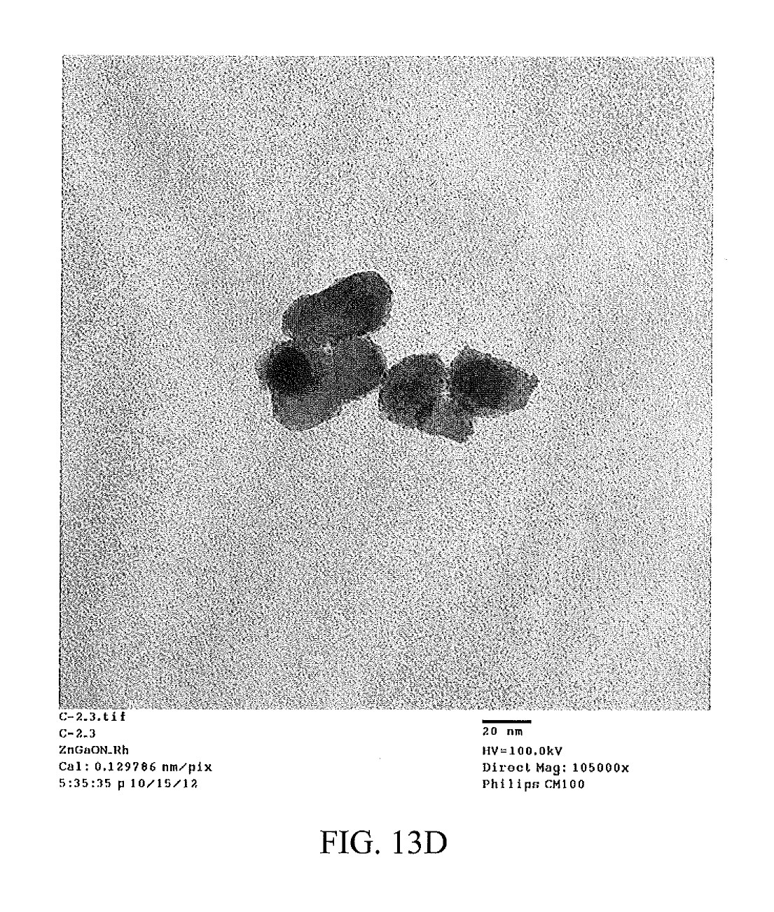

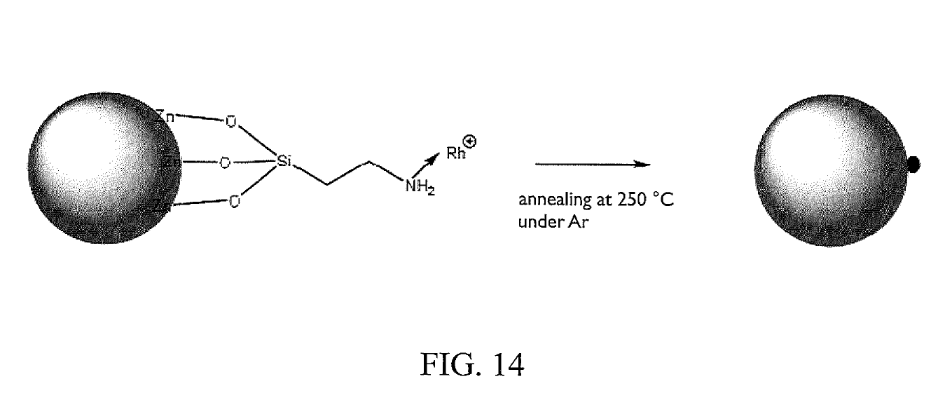

FIGS. 13A, 13B, 13C, and 13D show TEM images where the surface of (Ga₁₋ₓZnₓ)(N₁₋ₓOₓ) particles are decorated with smaller co-catalyst. FIG. 14 represents the coupling of the catalyst to the surface of (Ga₁₋ₓZnₓ)(N₁₋ₓOₓ) nanoparticles.

### 7. EXAMPLE 6

### Devices Using Nanocrystalline (Ga₁₋ₓZnₓ)(N₁₋ₓOₓ)

The photon-driven chemistry of nanoscale (Ga₁₋ₓZnₓ)(N₁₋ₓOₓ) can be used in a broad range of redox reactions that are not spontaneous or are too slow to occur without the photo-driven component (oxy(nitride)). Examples include fuel generation (e.g., H₂ generation by water splitting, or CO₂ reduction to make liquid fuels), oxidation of organic pollutants in water, and killing of bacteria on surfaces (for which TiO₂ is currently used, but TiO₂ does not absorb sunlight, only UV light). Industrial uses further include epoxidation of organic double bonds, which is an important industrial process that can be difficult and/or inefficient using other methods and devices. While the present devices and uses thereof can be implemented in various ways, two examples include a photoelectrochemical device and a free-particle based device.

With respect to the photoelectrochemical device, the photoelectrochemical device can be configured for oxidation of various materials or reactants, including water (which is part of water splitting). Various photoelectrochemical devices are known, but the present technology allows configuring a photoelectrochemical device with oxy(nitrides) as the present nano materials demonstrate a greater effectiveness than the bulk form.

With respect to a free-particle based device, the present nanoparticles of (Ga₁₋ₓZnₓ)(N₁₋ₓOₓ) can be suspended in a solution that contains one or more reactants, where light exposure allows each illuminated nanoparticle to act as an individual photochemical reactor. As described, photoelectrochemical (PEC) production of hydrogen is a promising renewable energy technology for generation of hydrogen for use in a hydrogen economy. The present PEC systems can use solar photons to generate a voltage in an electrolysis cell sufficient to electrolyze water, producing H₂ and O₂ gases. As examples, four basic system configurations can be employed. Each system comprises a PEC reactor that generates H₂ and O₂, a gas processing system that compresses and purifies the output gas stream, and one or more ancillary components.

The first two of the four system configurations utilize aqueous reactor beds containing colloidal suspensions of PV-active nanoparticles of (Ga₁₋ₓZnₓ)(N₁₋ₓOₓ), each nanoparticle able to achieve sufficient bandgap voltage to carry out the electrolysis reaction. The third and fourth system configurations use multi-layer planar PV cells in electrical contact with a small electrolyte reservoir and produce oxygen gas on the anode face and hydrogen gas on the cathode face. They are positioned in fixed or steered arrays facing a light source, such as the sun.

Aspects of these four systems include:
1. Type-1: A single electrolyte -filled reactor bed containing a colloidal suspension of (Ga₁₋ₓZnₓ)(N₁₋ₓOₓ) nanoparticles which produce a mixture of H₂ and O₂ product gases.
2. Type-2: Dual electrolyte-filled reactor beds containing colloidal suspensions of (Ga₁₋ₓZnₓ)(N₁₋ₓOₓ) nanoparticles, with one bed carrying out the H₂O=>½O₂+2 H+ half-reaction, the other bed carrying out the 2H+=>H₂ half-reaction, and including a mechanism for circulating the ions between beds.
3. Type-3: A fixed (Ga₁₋ₓZnₓ)(N₁₋ₓOₓ) nanoparticle planar array tilted toward the sun at local latitude angle, using multi-junction PV/PEC cells immersed in an electrolyte reservoir.
4. Type-4: A (Ga₁₋ₓZnₓ)(N₁₋ₓOₓ) nanoparticle solar concentrator system, using reflectors to focus the solar flux at a 10:1 intensity ratio onto multi junction PV/PEC cell receivers immersed in an electrolyte reservoir and pressurized (e.g., 300 psi).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

### H. REFERENCES

1. Maeda, K.; Domen, K., New non-oxide photocatalysts designed for overall water splitting under visible light. J. Phys. Chem. C 2007, 111, (22), 7851-7861.
2. Maeda, K.; Domen, K., Solid Solution of GaN and ZnO as a Stable Photocatalyst for Overall Water Splitting under Visible Light, Chem. Mater. 2010, 22, (3), 612-623.
3. Maeda, K.; Domen, K., Photocatalytic Water Splitting: Recent Progress and Future Challenges. J. Phys. Chem. Lett. 2010, 1, (18), 2655-2661.
4. Maeda, K.; Teramura, K.; Lu, D. L.; Takata, T.; Saito, N.; Inoue, Y.; Domen, K., Photocatalyst releasing hydrogen from water—Enhancing catalytic performance holds promise for hydrogen production by water splitting in sunlight. Nature 2006, 440, (7082), 295-295.
5. Chen, H. Y.; Wang, L. P.; Bai, J. M,; Hanson, J. C.; Warren, J. B.; Muckerman, J. T.; Fujita, E.; Rodriguez, J. A., In Situ XRD Studies of ZnO/GaN Mixtures at High Pressure and High Temperature: Synthesis of Zn-Rich (Ga(1-x)Zn(x))(N(1-x)O(x)) Photocatalysts. J. Phys. Chem. C 2010, 114, (4), 1809-1814.
6. Di Valentin, C., Electronic Structure of (Ga(1-x)Zn(x))N(1-x)O(x) Photocatalyst for Water Splitting by Hybrid Hartree-Fock Density Functional Theory Methods. J. Phys. Chem. C 2010, 114, (15), 7054-7062.

7. Dou, M.; Persson, C., Band gap reduction and dielectric function of Ga1-xZnxN1-xOx and In1-xZnxN1xOx alloys. Phys. Status Solidi A 2012, 209, (1), 75-78.
8. Hirai, T.; Maeda, K.; Yoshida, M.; Kubota, J.; Ikeda, S.; Matsumura, M.; Domen, K., Origin of visible light absorption in GaN-Rich (Ga1-xZnx)(N1-xOx) photocatalysts. J. Phys. Chem. C 2007, 111, (51), 18853-18855
9. Huda, M. N.; Yan, Y. F.; Wei, S. H.; Al-Jassim, M. M., Electronic structure of ZnO:GaN compounds: Asymmetric bandgap engineering. Phys. Rev. B 2008, 78, (19), 195204/1-5.
10. Jensen, L. L.; Muckerman, J. T.; Newton, M. D., First-principles studies of the structural and electronic properties of the (Ga(1-x)Zn(x))(N(1-x)O(x)) solid solution photocatalyst. J. Phys. Chem. C 2008, 112, (9), 3439-3446.
11. Lee, Y. C.; Lin, T. Y.; Wu, C. W.; Teng, H. S.; Hu, C. C.; Hu, S. Y.; Yang, M. D., Visible luminescence properties of (Ga(1-x)Zn(x))(N(1-x)O(x)) solid solution (x=0.22). J. Appl. Phys. 2011, 109, (7), 073506/1-5.
12. Li, L.; Muckerman, J. T.; Hybertsen, M. S.; Allen, P. B., Phase diagram, structure, and electronic properties of (Ga(1-x)Zn(x))(N(1-x)O(x)) solid solutions from DFT-based simulations. Phys. Rev. B 2011, 83, (13), 134202/1-6.
13. McDermott, E. J.; Kurmaev, E. Z.; Boyko, T. D.; Finkelstein, L. D.; Green, R. J.; Maeda, K.; Domen, K.; Moewes, A., Structural and Band Gap Investigation of GaN:ZnO Heterojunction Solid Solution Photocatalyst Probed by Soft X-ray Spectroscopy. J. Phys. Chem. C 2012, Articles ASAP.
14. Wang, S. Z.; Wang, L. W., Atomic and Electronic Structures of GaN/ZnO Alloys. Phys. Rev. Lett. 2010, 104, (6), 065501/1-4.
15. Wei, W.; Dai, Y.; Yang, K.; Guo, M.; Huang, B., Origin of the Visible Light Absorption of GaN-Rich Ga1-x ZnxN1-xOx (x=0.125) Solid Solution. J. Phys. Chem. C 2008, 112, (40),15915-15919.
16. Yoshida, M.; Hirai, T.; Maeda, K.; Saito, N.; Kubota, J.; Kobayashi, H.; Inoue, Y.; Domen, K., Photoluminescence Spectroscopic and Computational Investigation of the Origin of the Visible Light Response of (Ga(1-x)Zn(x))(N(1-x)O(x)) Photocatalyst for Overall Water Splitting. J. Phys. Chem, C 2010, 114, (36), 15510-15515.
17. Yu, H. G., An optimal density functional theory method for GaN and ZnO. Chem. Phys. Lett. 2011, 512, (4-6), 231-236.
18. Wang, J. P.; Huang, B. B.; Wang, Z. Y.; Wang, P.; Cheng, H. F.; Zheng, Z. K.; Qin, X. Y.; Zhang, X. Y.; Dai, Y.; Whangbo, M. H., Facile synthesis of Zn-rich(GaN)(1-x)(ZnO)(x) solid solutions using layered double hydroxides as precursors. J. Mater. Chem. 2011, 21, (12), 4562-4567.
19. Hisatomi, T.; Maeda, K.; Takanabe, K.; Kubota, J.; Domen, K., Aspects of the Water Splitting Mechanism on (Ga(1-x)Zn(x))(N(1-x)O(x)) Photocatalyst Modified with Rh(2-y)Cr(y)O(3) Cocatalyst. J. Phys. Chem. C 2009, 113, (51), 21458-21466.
20. Maeda, K.; Teramura, K.; Domen, K., Effect of post-calcination on photocatalytic activity of (Ga1-xZnx)(N1-xOx) solid solution for overall water splitting under visible light. J. Catal. 2008, 254, (2), 198-204.
21. Kay, A.; Cesar, I.; Gratzel, M., New benchmark for water photooxidation by nanostructured alpha-Fe2O3 films. J. Am. Chem. Soc. 2006, 128, (49), 15714-15721.
22. Sabio, E. M.; Chamousis, R. L.; Browning, N. D.; Osterloh, F. E., Photocatalytic Water Splitting with Suspended Calcium Niobium Oxides: Why Nanoscale is Better than Bulk A Kinetic Analysis. J. Phys. Chem. C 2012, 116, (4), 3161-3170.
23. Han, W. Q.; Liu, Z. X.; Yu, H. G., Synthesis and optical properties of GaN/ZnO solid solution nanocrystals. Appl. Phys. Lett. 2010, 96, (18), 183112/1-3.
24. Han, W. Q.; Ward, M. J.; Sham, T., Effect of Indium Doping on the Growth and Physical Properties of Ultrathin Nanosheets of GaInN/ZnO Solid Solution. J. Phys. Chem. C 2011, 115, (10), 3962-3967.
25. Han, W. Q.; Zhang, Y.; Nam, C. Y.; Black, C. T.; Mendez, E. E., Growth and electronic properties of GaN/ZnO solid solution nanowires. Appl. Phys. Lett. 2010, 97, (8), 083108/1-3.
26. Byun, H. J.; Kim, J. U,; Yang, H., Blue, green, and red emission from undoped and doped ZnGa(2)O(4) colloidal nanocrystals. Nanotechnology 2009, 20, (49), 495602/1-6.
27. Becheri, A.; Durr, M.; Lo Nostro, P.; Baglioni, P., Synthesis and characterization of zinc oxide nanoparticles: application to textiles as UV-absorbers, J. Nanopart. Res. 2008, 10, (4), 679-689.
28. Amirav, L.; Alivisatos, A. P., Photocatalytic Hydrogen Production with Tunable Nanorod Heterostructures. J. Phys. Chem, lett. 2010, 1, (7), 1051-1054.
29. Maeda, K.; Teramura, K.; Takata, T.; Hata, M.; Saito, N.; Toda, K.; Inoue, Y.; Kobayashi, H.; Domen, K., Overall water splitting on (Ga1-xZnx)(N1-xOx) solid solution photocatalyst: Relationship between physical properties and photocatalytic activity. J. Phys. Chem. B 2005, 109, (43), 20504-20510.
30. Joo, J.; Kwon, S. G.; Yu, J. H.; Hyeon, T., Synthesis of ZnO Nanocrystals with Cone, Hexagonal Cone, and Rod Shapes via Non-Hydrolytic Ester Elimination Sol-Gel Reactions. Adv. Mater, 2005, 17, (15), 1873-1877.
31. Sun, X.; Maeda, K.; Le Faucheur, M.; Teramura, K.; Domen, K., Preparation of (Ga1-xZnx) (N1-xOx) solid-solution from ZnGa2O4 and ZnO as a photo-catalyst for overall water splitting under visible light. Appl. Catal. A-Gen. 2007, 327, (1), 114-121.
32. Yashima, M.; Yamada, H.; Maeda, K.; Domen, K., Experimental visualization of covalent bonds and structural disorder in a gallium zinc oxynitride photocatalyst (Ga(1-x)Zn(x))(N(1-x)O(x)): origin of visible light absorption. Chem. Common. 2010, 46, (14), 2379-2381.
33. Chen, H.; Wen, W.; Wang, Q.; Hanson, J. C.; Muckerman, J. T.; Fujita, E.; Frenkel, A. I.; Rodriguez, J. A., Preparation of (Ga(1-x)Zn(x))(N(1-x)O(x)) Photocatalysts from the Reaction of NH(3) with Ga(2)O(3)/ZnO and ZnGa(2)O(4): In Situ Time-Resolved XRD and XAFS Studies. J. Phys. Chem. C 2009, 113, (9), 3650-3659.
34. Tolbert, S. H.; Alivisatos, A. P., High-Pressure Structural Transformations in Semiconductor Nanocrystals. Annual Review of Physical Chemistry 1995, 46, (1), 595-626.
35. Suryanarayana, C.; Grant Norton, M., X-Ray diffraction: a practical approach New York: Plenum Press: 1998
36. Tauc plots for a direct-gap semiconductor give band gaps that are red-shifted by ˜0.1 eV, while those for an indirect-gap material are blue-shifted by ˜0.1 eV.
37. Calculations were carried out using the AM 1.5 solar spectrum (ASTM G173).
38. Byun, H. J.; Kim, J. U.; Yang, H., Blue, green, and red emission from undoped and doped ZnGa(2)O(4) colloidal nanocrystals. Nanotechnology 2009, 20, (49), 95602/1-6.
39. Sun, S. H.; Zeng, H.; Robinson, D. B.; Raoux, S.; Rice, P. M.; Wang, S. X.; Li, G. X., Monodisperse MFe2O4 (M=Fe, Co, Mn) nanoparticles. J. Am. Chem. Soc. 2004, 126, (1), 273-279.
40. Becheri, A.; Durr, M.; Lo Nostro, P.; Baglioni, P., Synthesis and characterization of zinc oxide nanoparticles: application to textiles as UV-absorbers. J. Nanopart. Res. 2008, 10, (4), 679-689. 9
41. Amirav, L.; Alivisatos, A. P., Photocatalytic Hydrogen Production with Tunable Nanorod Heterostructures. J. Phys. Chem. lett. 2010, 1, (7), 1051-1054.
42. Suryanarayana, C.; Grant Norton, M., X-Ray diffraction: a practical approach New York: Plenum Press: 1998

What is claimed is:

1. A nanocrystal comprising (Ga_{1-X}Zn_{X})(N_{1-X}O_{X}), wherein 0<x<1.

2. The nanocrystal of claim 1, wherein about 0.125<x<1,

3. The nanocrystal of claim 1, wherein about 0.85<x<about 0.95.

4. The nanocrystal of claim 1, wherein x is about 0.90.

5. The nanocrystal of claim 1, wherein the size of the nanocrystal is about 5 nm to about 50 nm.

6. The nanocrystal of claim 1, wherein the size of the nanocrystal is about 8 nm to about 25 nm.

7. The nanocrystal of claim 1, wherein the size of the nanocrystal is about 10 nm.

8. The nanocrystal of claim 1, wherein the nanocrystal has single-crystallinity.

9. The nanocrystal of claim 1, wherein the nanocrystal comprises a co-catalyst.

10. The nanocrystal of claim 9, wherein the co-catalyst comprises Rh_{2-y}Cr_{y}O₃, wherein y is <2.

11. A composition comprising nanocrystalline ZnGa₂O₄ and nanocrystalline ZnO.

12. The composition of claim 11, wherein the composition further comprises NH₃.

13. The composition of claim 12, wherein the nanocrystalline ZnGa₂O₄ comprises a capping moiety.

14. The composition of claim 13, wherein the capping moiety comprises 3-mercaptopropionic acid (MPA).

15. The composition of claim 12, wherein the composition produces (Ga_{1-X}Zn_{X})(N_{1-X}O_{X}) nanocrystals upon heating, wherein 0<x<1.

16. The composition of claim 15, wherein a ratio of ZnGa₂O₄ to ZnO determines the value of x.

17. The composition of claim 16, wherein the ratio of ZnGa₂O₄to ZnO is about 1:3 to about 1:199.

18. A composition comprising nanocrystalline Ga₂O₃ and nanocrystalline ZnO.

19. The composition of claim 18, wherein the composition further comprises NH₃.

20. The composition of claim 19, wherein the nanocrystalline Ga₂O₃ comprises a capping moiety.

21. The composition of claim 20, wherein the capping moiety comprises 3-mercaptopropionic acid (MPA).

22. The composition of claim 19, wherein the composition produces (Ga_{1-X}Zn_{X})(N_{1-X}O_{X}) nanocrystals upon heating, wherein 0<x<1.

23. The composition of claim 22, wherein a ratio of Ga₂O₃ to ZnO determines the value of x.

24. The composition of claim 23, wherein the ratio of Ga₂O₃ to ZnO is about 0.01 to about 0.99.

25. A method of synthesizing a nanocrystal comprising the steps of:
a) combining nanocrystalline ZnO and one of nanocrystalline ZnGa₂O₄ and nanocrystalline Ga₂O₃; and
b) heating the combined nanocrystalline ZnO and one of nanocrystalline ZnGa₂O₄ and nanocrystalline Ga₂O₃ in the presence of a nitridation agent,
thereby forming a nanocrystal comprising (Ga_{1-X}Zn_{X})(N_{1-X}O_{X}), wherein 0<x<1.

26. The method of claim 25, wherein about 0.125<x<1.

27. The method of claim 25, wherein about 0.85<x<about 0.95.

28. The method of claim 25, wherein x is about 0.90.

29. The method of claim 25, wherein the nitridation agent comprises NH₃.

30. The method of claim 29, wherein the NH₃ is anhydrous.

31. The method of claim 29, wherein the NH₃ is under 1 atmosphere.

32. The method of claim 25, wherein a ratio of ZnGa₂O₄to ZnO is 1:3 to 1:199.

33. The method of claim 25, wherein a ratio of ZnO to one of ZnGa₂O₄ and Ga₂O₃ determines the value of x.

34. The method of claim 25, wherein the nanocrystalline ZnGa₂O₄ or Ga₂O₃ and nanocrystalline ZnO are deposited from a dispersion.

35. The method of claim 25, wherein the heating ranges from 500° C. to 850° C.

36. The method of claim 25, wherein the heating is at about 650° C.

37. The method of claim 25, wherein the heating lasts for about 10 hrs.

38. The method of claim 25, wherein the nanocrystal is single-crystalline.

39. The method of claim 25, wherein the nanocrystal is about 8 nm to about 25 nm.

40. The method of claim 25, wherein the nanocrystal is about 10 nm.

41. The method of claim 25, wherein one of nanocrystalline ZnGa₂O₄ and nanocrystalline Ga₂O₃ comprises a capping moiety prior to the heating.

42. The method of claim 25, wherein the capping moiety comprises 3-mercaptopropionic acid (MPA).

43. A device comprising the nanocrystal of claim 1.

44. The device of claim 43, wherein the device produces H₂.

45. The device of claim 43, wherein the device splits water.
